(19) United States
(12) Patent Application Publication
(10) Pub. No.: US 2021/0197813 A1
(43) Pub. Date: Jul. 1, 2021

(54) SYSTEMS AND METHODS FOR APPROPRIATE SPEED INFERENCE

(71) Applicant: Lyft, Inc., San Francisco, CA (US)

(72) Inventors: John Rogers Houston, Los Altos, CA (US); Sammy Omari, Los Altos, CA (US); Matthew Swaner Vitelli, San Francisco, CA (US)

(21) Appl. No.: 16/729,263

(22) Filed: Dec. 27, 2019

(51) Int. Cl. B60W 30/14; G05D 1/02; G06N 20/00; G06N 3/08

(52) U.S. Cl. CPC B60W 30/143; G06N 3/08; G06N 20/00; G05D 1/0223

(57) ABSTRACT

In one embodiment, a method includes, by a computing system associated with a vehicle, receiving sensor data of an environment of the vehicle, the sensor data being captured by one or more sensors associated with the vehicle, generating, based on the sensor data, one or more representations of the environment of the vehicle, determining a target speed for the vehicle by processing the one or more representations of the environment of the vehicle using a machine-learning model that has been trained using human-driven vehicle speed observations and corresponding representations of environments associated with the observations, determining a trajectory plan and a planned speed for the vehicle based on at least the target speed, and causing the vehicle to perform one or more operations based on the trajectory plan and the planned speed.

### BACKGROUND

A modern vehicle may include one or more sensors or sensing systems for monitoring the vehicle and environment. For example, the vehicle may use speed sensors to measure the vehicle speed and may use a GPS to track the location of the vehicle. One or more cameras or LiDAR may be used to detect objects in the environment surrounding the vehicle. The vehicle may use one or more computing systems (e.g., an on-board computer) to collect and process data from the sensors. The computing systems may store the collected data in on-board storage space or upload the data to a cloud using a wireless connection. Map data, such as the locations of roads and information associated with the roads, such as lane and speed limit information, may also be stored in on-board storage space and/or received from the cloud using the wireless connection.

The computing systems may perform processing tasks on the map data, the collected data, and other information, such as a specified destination, to operate the vehicle. The computing systems may determine a target speed and heading for the vehicle, and operations, such as speeding up or slowing down, to cause the vehicle to travel at the target speed. The target speed may be determined based on speed limits encoded in the map data, a desired comfort level, and obstacles. The vehicle may adjust the target speed as the vehicle approaches obstacles. However, as the environment becomes more complex, e.g., a pedestrian is about to cross a crosswalk, and the vehicle has to stop, determining the target speed becomes more difficult. As the number of obstacles in the environment increases, the probability of multiple obstacles entering the vehicle's increases, and determining the target speed becomes more complex.

### BRIEF DESCRIPTION OF THE DRAWINGS

FIG. 1 illustrates an example block diagram of an algorithmic navigation pipeline.

FIG. 2A illustrates an example image-based perception module.

FIG. 2B illustrates an example vehicle system having an example prediction module that predicts appropriate target speeds based on images of the environment.

FIG. 2C illustrates an example vehicle system having an example prediction module that predicts appropriate target speeds based on images of the environment and predicted future locations of the vehicle and/or agents.

FIG. 2D illustrates an example vehicle system having a planning module that generates trajectory plans based on predicted target speeds.

FIG. 3 illustrates an example convolutional neural network.

FIG. 4A illustrates an example point-based perception module.

FIG. 4B illustrates an example vehicle system having an example prediction module that predicts appropriate target speeds based on point clouds that represent the environment.

FIG. 5 illustrates an example point-based neural network.

FIG. 6 illustrates an example urban vehicle environment.

FIG. 7A illustrates an example top view image of an urban vehicle environment.

FIGS. 7B and 7C illustrate example top view images of an urban vehicle environment captured at past times.

FIG. 8 illustrates an example residential vehicle environment.

FIG. 9A illustrates an example top view image of a residential vehicle environment.

FIGS. 9B and 9C illustrate example top view images of a residential vehicle environment captured at past times.

FIG. 10 illustrates an example top-down image that includes predicted vehicle location points.

FIG. 11 illustrates an example front view image that includes predicted vehicle location points.

FIG. 12 illustrates an example method for predicting appropriate vehicle speeds and generating trajectory plans based on the appropriate speeds.

FIG. 13 illustrates an example method for training a machine-learning model to predict appropriate target speeds.

FIG. 14 illustrates an example situation for a data-gathering vehicle system to collect vehicle data of a nearby vehicle and contextual data of the surrounding environment.

FIG. 15 illustrates an example block diagram of a transportation management environment for matching ride requestors with autonomous vehicles.

FIG. 16 illustrates an example computer system.

### DESCRIPTION OF EXAMPLE EMBODIMENTS

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described. In addition, the embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The tasks performed by a vehicle navigation system may include determining an appropriate speed at which the vehicle is to travel at a particular time and place. The appropriate speed may be a single numeric speed, or any speed within a numeric range of speeds, that the vehicle should attempt to reach in a particular environment. The environment may be a representation of the physical world near the vehicle, and may be constructed from sensor data received from sensors including cameras, LiDAR point clouds, radars, or any other sensory devices that may be useful. The appropriate speed may depend on factors such as the posted speed limit, the locations and speeds of other vehicles and pedestrians, and characteristics of the road and surrounding area.

The problem of determining the appropriate speed for real-world environments is difficult to solve because the environments can be complex, with many objects potentially moving unpredictably. Numerous factors in the environment may influence the appropriate speed, and the mapping from these factors to an appropriate speed is difficult to specify using rules or heuristics. The appropriate speed should neither be too high nor too low for the environment, since speeds that are too high or too low may be unsafe or illegal. Thus, the appropriate speed may be a trade-off between higher speeds, which can shorten the time needed to reach the destination, and lower speeds, which may be safer. Also, higher speeds may be expected by other drivers in particular environments, and lower speeds may be expected by other drivers in other environments, so the appropriate speed should be related to the speeds of other vehicles in the environment to avoid collisions or other issues that may result from large differences between the speeds of the vehicle and other drivers' vehicles. Further, the appropriate speed should be low enough to provide the vehicle sufficient time to avoid collisions with obstacles that may unexpectedly appear. Because of these constraints, determining appropriate speeds in real-world environments can be quite difficult.

As an example, if there are many pedestrians or the road is narrow, the appropriate speed may be relatively low. If the road is wide and traffic is light, the appropriate speed may be relatively high. Thus, the appropriate speed may change over time in response to changes in the environment as the vehicle moves through different points along its planned trajectory. The posted speed limit alone is not necessarily an appropriate speed for the vehicle. For example, although the speed limit on a street may be 35 miles per hour (mph), if pedestrians are walking near the vehicle, then the appropriate speed may be well below 35 mph. As another example, traveling at a speed below the speed limit may be inappropriate if traffic is moving at speeds substantially above the speed limit. The appropriate speed may be a goal that the vehicle does not necessarily reach, as obstacles may appear unexpectedly, or there may be other changes in the environment that may cause the vehicle's planning module to select a speed different from the determined appropriate speed.

Existing vehicle systems may determine the speed at which the vehicle is to travel by initially selecting a planned speed, e.g., based on the posted speed limit, and causing the vehicle to speed up or slow down, as appropriate, to reach the planned speed. Existing systems may then adjust the vehicle's speed reactively, e.g., by causing the vehicle's brakes to be applied in response to appearance of an obstacle. However, this reactive technique can result in decisions being made too late to be effective. For example, if an obstacle is detected in the vehicle's path, and the vehicle is moving at a high speed, the vehicle's brakes may be physically unable to reduce the speed sufficiently within the available time to avoid a collision with the obstacle. To avoid a collision in this example, the speed would have to be reduced at a time prior to detection of the object. Thus, the reactive technique does not solve the problem of determining an appropriate speed in complex environments. As the number of obstacles in the environment increases, obstacles in the environment are more likely to reduce the vehicle's appropriate speed. For example, if a pedestrian about to cross a crosswalk, and the crosswalk is in the vehicle's path, the planned speed may need to be reduced. Existing systems may determine the planned speed using rules, such as reducing the planned speed in proportion to the number of nearby obstacles, or reducing the planned speed if there is a pedestrian near a crosswalk. However, such rules may oversimplify the planned speed calculation, and result in planned speeds that are too low or too high.

As another example, existing systems may determine the planned speed based on distances between the vehicle and other vehicles. On a busy street having a posted speed limit of 35 mph, driving at 35 mph while passing parked vehicles may be appropriate. In contrast, on a residential street that also has a posted 35 mph speed limit and parked vehicles, driving at 35 mph may be unsafe and thus inappropriate. The appropriate speed on a residential street may be substantially less than the posted speed limit, depending on the particular environment. For example, existing techniques may determine the planned speed based on the distance between the vehicle and other vehicles. Such existing techniques may not reduce the planned speed on the residential street because the lateral distance between the vehicle and the parked vehicles is similar on both streets, and is not an accurate indication of the appropriate speed in this example. Thus, existing techniques can fail to determine a planned speed that is appropriate, particularly in situations that involve multiple obstacles or are not covered by speed calculation rules.

In particular embodiments, a vehicle system may provide a technical solution to these problems by using a machine-learning model to predict appropriate speeds for the vehicle based on representations of the vehicle's environment. The representations of the environment may be, e.g., top-down images, and may be generated from camera images or other sensor data. The appropriate speed for a particular environment may depend on numerous factors in the environment, many of which are present in the sensor data. These factors may include the locations of objects such as vehicles, pedestrians, and stationary objects, the speeds of vehicles or pedestrians, the size and shape of the road, and so on. Training the machine-learning model using known appropriate speeds based on representations of environments that contain these factors produces a model that may be used to predict appropriate speeds for other environments by identifying similar factors in representations of the other environments. Further, additional relevant information, such as a trajectory of the vehicle, may be generated based on the environment and used as input to the machine-learning model. Providing the trajectory as input to the model may increase the accuracy of the predicted appropriate speed, since the appropriate speed may be different depending on the area of the environment toward which the vehicle is headed.

In particular embodiments, the model may be trained by using it to predict appropriate speeds for particular environments (e.g., images), and comparing the predicted appropriate speeds to the actual speeds at which vehicles were driven by human drivers in those environments. If a predicted speed differs from an actual speed, the model may be updated to reflect that the actual speed is the appropriate speed for that environment. The model may be a neural network, and the training process may generate a set of weights for use by the model. The trained model may be loaded into a vehicle system, which may use the model to determine appropriate speeds for the vehicle based on real-time sensor data. The vehicle system may use the appropriate speeds as input to a trajectory planner, so that the planned speeds of the trajectories followed by the vehicle are based on the appropriate speeds.

In particular embodiments, predicting appropriate speeds as disclosed herein has advantages over existing techniques for determining speeds at which vehicles are to travel because, for example, the disclosed predictive techniques can determine an appropriate speed proactively in a complex environment based on factors that are related to the appropriate speed, such as the number of objects, their locations, and speeds. Collisions may be avoided because the vehicle is traveling at a speed appropriate for the environment. Further, processing complex environments containing numerous objects is difficult with existing techniques, which may use only a small subset of the objects in the environment and/or the speed limit to determine an appropriate speed for the vehicle. In contrast, the disclosed technique can determine appropriate speeds for a vehicle based on image features that correspond to the location, size, shape, speed, and color of any number of objects that are distinguishable from other objects in an image by on one or more of these features.

For example, existing techniques may use the posted speed limit as a target appropriate speed, and attempt to accelerate to that speed. Existing techniques can reduce the appropriate speed based on the speed of another nearby moving object or the distance to a nearby moving or stationary object. If an obstacle appears, existing techniques may react by braking to avoid a collision with the obstacle. However, the brakes may be applied too late to avoid a collision, as described above. Further, in more complex environments, there may be multiple obstacles to avoid. As an example, a second obstacle, such as a pedestrian crossing a crosswalk, may be detected in the vehicle's path, and a particular vehicle speed may be needed to avoid a collision with at least one of the two obstacles. That is, the braking applied to reduce the speed and avoid a collision with the first obstacle may cause the vehicle to slow down sufficiently to cause a collision with the pedestrian. Existing techniques may be unable to process both obstacles, and may maintain the speed that avoids the first obstacle while potentially colliding with the second. Using the disclosed techniques for predicting appropriate speeds, both obstacles are included in the prediction, and the predicted appropriate speed may avoid the collision with both obstacles.

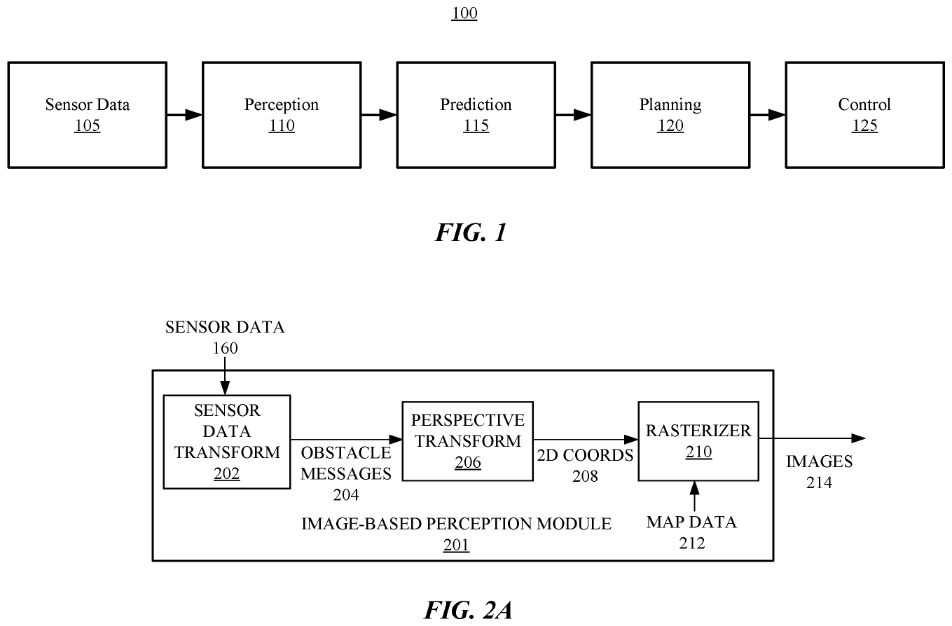

FIG. 1 illustrates an example block diagram of an algorithmic navigation pipeline. In particular embodiments, an algorithmic navigation pipeline 100 may include a number of computing modules, such as a sensor data module 105, perception module 110, prediction module 115, planning module 120, and control module 125. Sensor data module 105 may obtain and pre-process sensor/telemetry data that is provided to perception module 110. Such data may be captured by any suitable sensors of a vehicle. As an example and not by way of limitation, the vehicle may have a Light Detection and Ranging (LiDAR) sensor that is configured to transmit pulsed laser beams in multiple directions and measure the reflected signal from objects surrounding vehicle. The time of flight of the light signals may be used to measure the distance or depth of the objects from the LiDAR. As another example, the vehicle may have optical cameras pointing in different directions to capture images of the vehicle's surrounding. Radars may also be used by the vehicle for detecting other vehicles and/or hazards at a distance. As further examples, the vehicle may be equipped with ultrasound for close range object detection, e.g., parking and obstacle detection or infrared cameras for object detection in low-light situations or darkness. In particular embodiments, sensor data module 105 may suppress noise in the sensor data or normalize the sensor data.

Perception module 110 is responsible for correlating and fusing the data from the different types of sensors of the sensor module 105 to model the contextual environment of the vehicle. Perception module 110 may use information extracted by multiple independent sensors to provide information that would not be available from any single type of sensors. Combining data from multiple sensor types allows the perception module 110 to leverage the strengths of different sensors and more accurately and precisely perceive the environment. As an example and not by way of limitation, image-based object recognition may not work well in low-light conditions. This may be compensated by sensor data from LiDAR or radar, which are effective sensors for measuring distances to targets in low-light conditions. As another example, image-based object recognition may mistakenly determine that an object depicted in a poster is an actual three-dimensional object in the environment. However, if depth information from a LiDAR is also available, the perception module 110 could use that additional information to determine that the object in the poster is not, in fact, a three-dimensional object.

Perception module 110 may process the available data (e.g., sensor data, data from a high-definition map, etc.) to derive information about the contextual environment. For example, perception module 110 may include one or more agent modelers (e.g., object detectors, object classifiers, or machine-learning models trained to derive information from the sensor data) to detect and/or classify agents present in the environment of the vehicle (e.g., other vehicles, pedestrians, moving objects). Perception module 110 may also determine various characteristics of the agents. For example, perception module 110 may track the velocities, moving directions, accelerations, trajectories, relative distances, or relative positions of these agents. In particular embodiments, the perception module 110 may also leverage information from a high-definition map. The high-definition map may include a precise three-dimensional model of the environment, including buildings, curbs, street signs, traffic lights, and any stationary fixtures in the environment. Using the vehicle's GPS data and/or image-based localization techniques (e.g., simultaneous localization and mapping, or SLAM), the perception module 110 could determine the pose (e.g., position and orientation) of the vehicle or the poses of the vehicle's sensors within the high-definition map. The pose information, in turn, may be used by the perception module 110 to query the high-definition map and determine what objects are expected to be in the environment.

Perception module 110 may use the sensor data from one or more types of sensors and/or information derived therefrom to generate a representation of the contextual environment of the vehicle. As an example and not by way of limitation, the representation of the external environment may include objects such as other vehicles, curbs, debris, objects, and pedestrians. The contextual representation may be limited to a maximum range of the sensor array (e.g., 50, 100, or 200 meters). The representation of the contextual environment may include information about the agents and objects surrounding the vehicle, as well as semantic information about the traffic lanes, traffic rules, traffic signs, time of day, weather, and/or any other suitable information. The contextual environment may be represented in any suitable manner. As an example and not by way of limitation, the contextual representation may be encoded as a vector or matrix of numerical values, with each value in the vector/matrix corresponding to a predetermined category of information. For example, each agent in the environment may be represented by a sequence of values, starting with the agent's coordinate, classification (e.g., vehicle, pedestrian, etc.), orientation, velocity, trajectory, and so on. Alternatively, information about the contextual environment may be represented by a raster image that visually depicts the agent, semantic information, etc. For example, the raster image may be a birds-eye view of the vehicle and its surrounding, up to a predetermined distance. The raster image may include visual information (e.g., bounding boxes, color-coded shapes, etc.) that represent various data of interest (e.g., vehicles, pedestrians, lanes, buildings, etc.).

The representation of the present contextual environment from the perception module 110 may be consumed by a prediction module 115 to generate one or more predictions of the future environment. For example, given a representation of the contextual environment at time to, the prediction module 115 may output another contextual representation for time t₁. For instance, if the to contextual environment is represented by a raster image, the output of the prediction module 115 may be another raster image (e.g., a snapshot of the current environment) that depicts where the agents would be at time t₁ (e.g., a snapshot of the future). In particular embodiments, prediction module 115 may include a machine-learning model (e.g., a convolutional neural network, a neural network, a decision tree, support vector machines, etc.) that may be trained based on previously recorded contextual and sensor data. For example, one training sample may be generated based on a sequence of actual sensor data captured by a vehicle at times t₀ and t₁. The captured data at times t₀ and t₁ may be used to generate, respectively, a first contextual representation (the training data) and a second contextual representation (the associated ground-truth used for training). During training, the machine-learning model may process the first contextual representation using the model's current configuration parameters and output a predicted contextual representation. The predicted contextual representation may then be compared to the known second contextual representation (i.e., the ground-truth at time t₁). The comparison may be quantified by a loss value, computed using a loss function. The loss value may be used (e.g., via back-propagation techniques) to update the configuration parameters of the machine-learning model so that the loss would be less if the prediction were to be made again. The machine-learning model may be trained iteratively using a large set of training samples until a convergence or termination condition is met. For example, training may terminate when the loss value is below a predetermined threshold. Once trained, the machine-learning model may be used to generate predictions of future contextual representations based on current contextual representations.

Planning module 120 may determine the navigation trajectories and particular driving operations (e.g., slowing down, speeding up, stopping, swerving, etc.) of the vehicle based on the predicted contextual representation generated by the prediction module 115. In particular embodiments, planning module 120 may utilize the predicted information encoded within the predicted contextual representation (e.g., predicted location or trajectory of agents, semantic data, etc.) and any other available information (e.g., map data, traffic data, accident reports, weather reports, target destinations, and any other suitable information) to determine one or more goals or navigation instructions for the vehicle. As an example and not by way of limitation, based on the predicted behavior of the agents surrounding the vehicle and the traffic data to a particular destination, planning module 120 may determine a particular navigation path and associated driving operations for the vehicle to avoid possible collisions with one or more agents.

In particular embodiments, planning module 120 may generate, based on a given predicted contextual representation, several different plans (e.g., goals or navigation instructions) for the vehicle. For each plan, the planning module 120 may compute a score that represents the desirability of that plan. For example, if the plan would likely result in the vehicle colliding with an agent at a predicted location for that agent, as determined based on the predicted contextual representation, the score for the plan may be penalized accordingly. Another plan that would cause the vehicle to violate traffic rules or take a lengthy detour to avoid possible collisions may also have a score that is penalized, but the penalty may be less severe than the penalty applied for the previous plan that would result in collision. A third plan that causes the vehicle to simply stop or change lanes to avoid colliding with the agent in the predicted future may receive the highest score. Based on the assigned scores for the plans, the planning module 120 may select the best plan to carry out. While the example above used collision as an example, the disclosure herein contemplates the use of any suitable scoring criteria, such as travel distance or time, fuel economy, changes to the estimated time of arrival at the destination, passenger comfort, proximity to other vehicles, the confidence score associated with the predicted contextual representation, etc.

Based on the plan generated by planning module 120, which may include one or more navigation path or associated driving operations, control module 125 may determine the specific commands to be issued to the actuators of the vehicle. The actuators of the vehicle are components that are responsible for moving and controlling the vehicle. The actuators control driving functions of the vehicle, such as for example, steering, turn signals, deceleration (braking), acceleration, gear shift, etc. As an example and not by way of limitation, control module 125 may transmit commands to a steering actuator to maintain a particular steering angle for a particular amount of time to move a vehicle on a particular trajectory to avoid agents predicted to encroach into the area of the vehicle. As another example, control module 125 may transmit commands to an accelerator actuator to have the vehicle safely avoid agents predicted to encroach into the area of the vehicle.

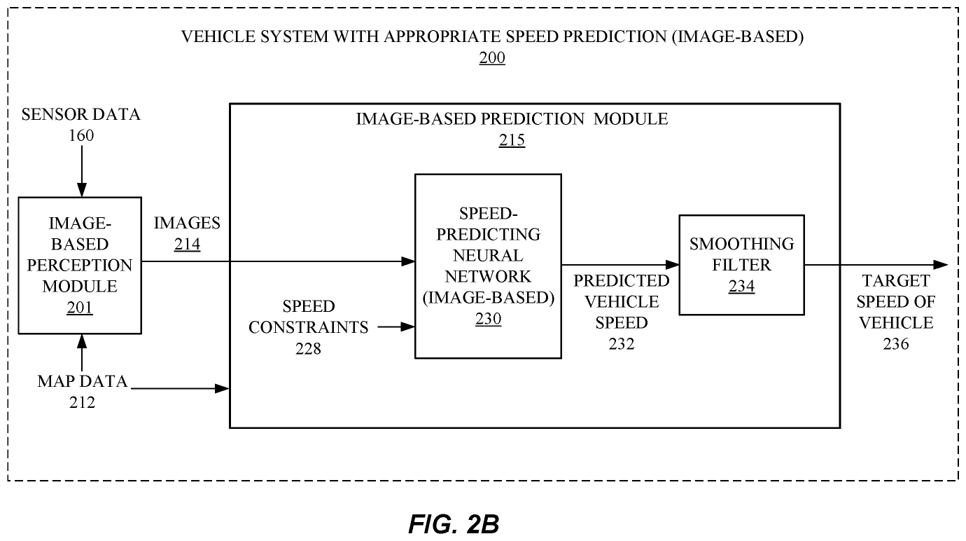

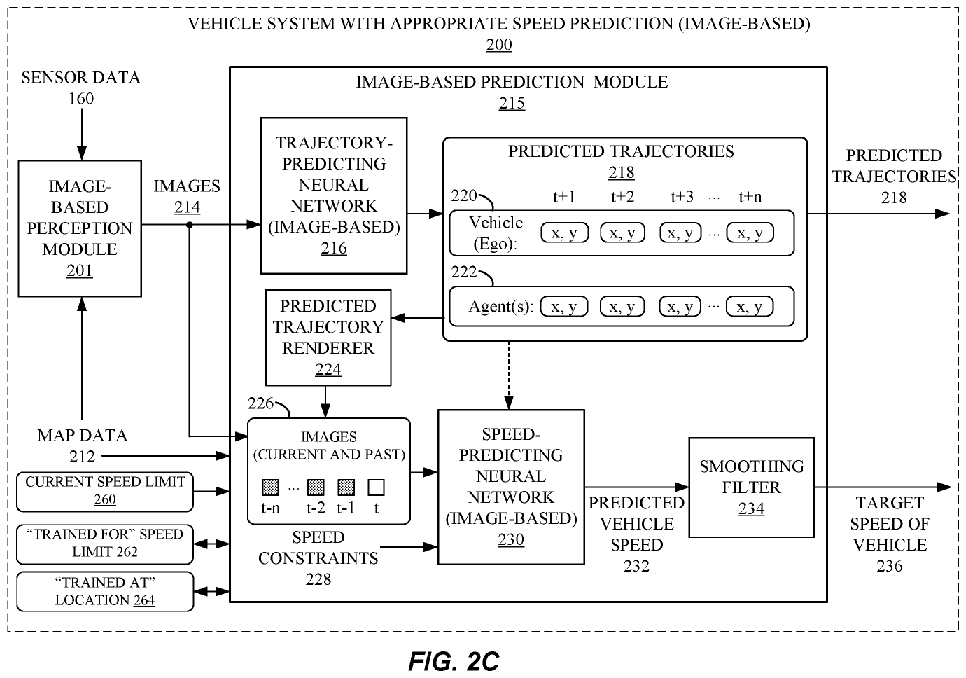

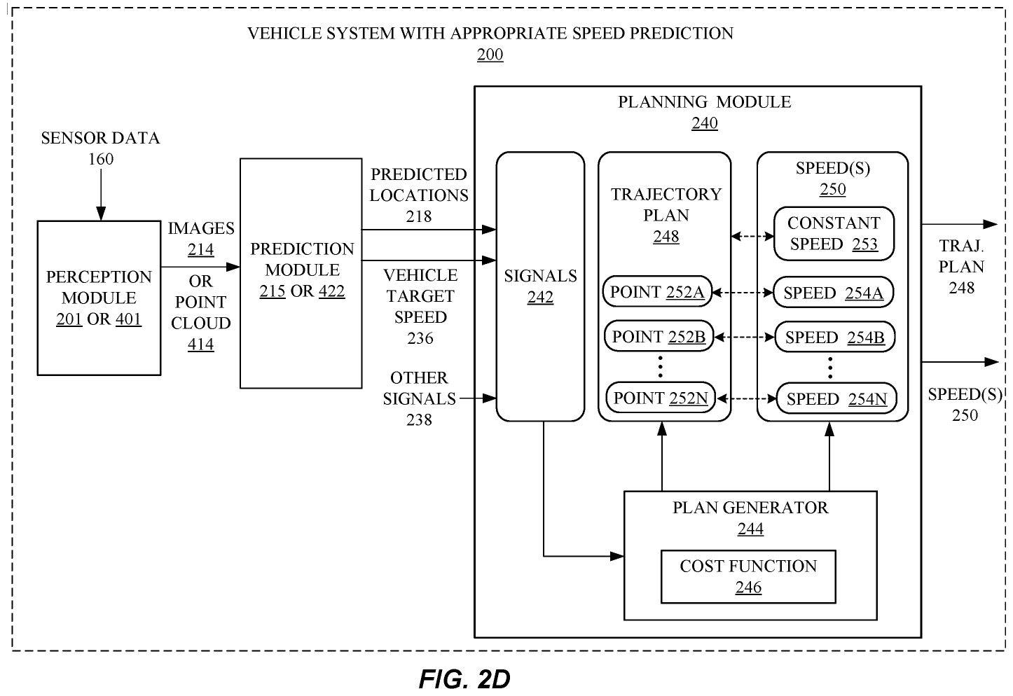

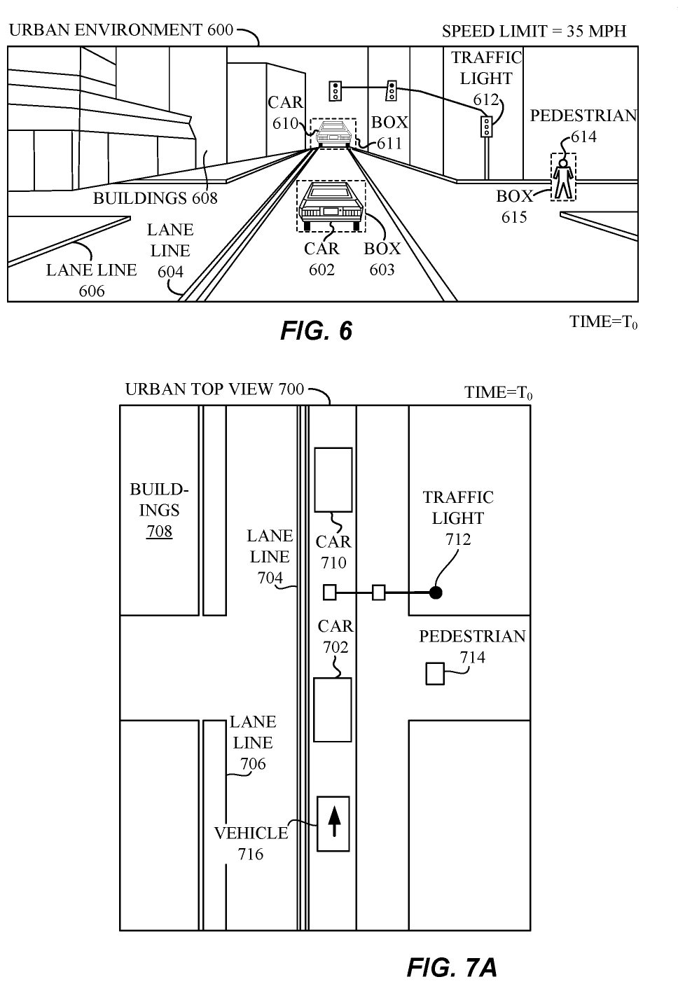

FIG. 2A illustrates an example image-based perception module 201. The perception module 201 may correspond to the perception module 110 in the navigation pipeline 100 of FIG. 1. As described above with reference to FIG. 1, the perception module 201 may use the sensor data 160 from one or more types of sensors and/or information derived therefrom to generate a representation of the contextual environment of the vehicle. The perception module 201 is referred to herein as “image-based” to indicate that it generates images 214. The images 214 may be, e.g., 2D 3-channel RGB images. The perception module 201 may receive sensor data 160, e.g., from a sensor data module 105, and may generate one or more images 214 based on the sensor data 160. The perception module 201 may include a sensor data transform 202, a perspective transform 206, and a rasterizer 210. The sensor data transform 202 may transform the sensor data 160 to obstacle messages 204 or other suitable representation. The obstacle messages 204 may be data items that describe physical obstacles or other physical objects in the environment near the vehicle. Each of the obstacle messages 204 may include a spatial representation of a corresponding physical obstacle, e.g., a representation of a bounding box of the physical obstacle, and information about the classification of the physical obstacle, e.g., as being a car, a pedestrian, or the like. The representation of the bounding box may be three-dimensional positions of corners of the bounding box, e.g., (x, y, z), coordinates or distances specified in units such as meters. Example bounding boxes are shown in FIG. 6.

For each of the obstacle messages 204, the perspective transform 206 may convert the bounding box coordinates specified by the obstacle message 204 to generate two-dimensional raster pixel coordinates 208 of a top-down view. The top-down view may be a bird's-eye view of the environment near the vehicle, and may include depictions of the vehicle, obstacles, and streets. A rasterizer 210 may generate images 214 based on the coordinates 208 as described below. Alternatively or additionally, the perspective transform 206 may convert the obstacle message (e.g., the bounding box coordinates or other suitable coordinates) to images of views other than top-down views, such as front, side, or rear views (e.g., from the point-of-view of front, side, or rear cameras on the vehicle). Thus, although the examples described herein refer to images having top-down views, images of different views may be used in addition to or instead of the top-down views.

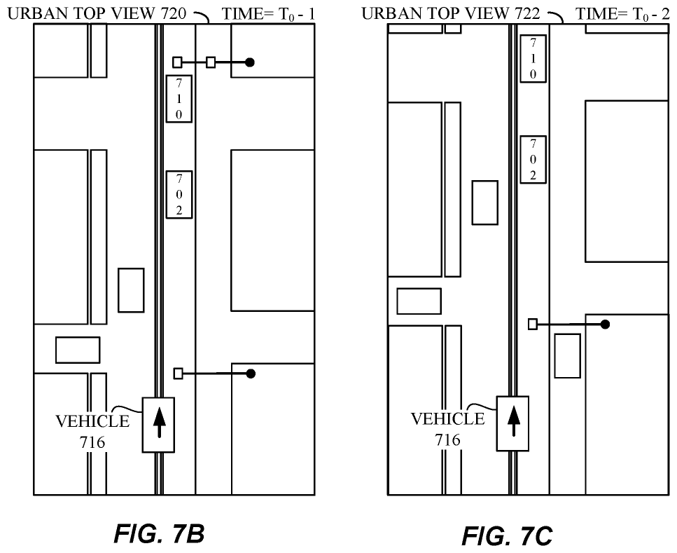

In particular embodiments, to generate the top-down view, each bounding box may be converted to two-dimensional (x, y) coordinates 208 of points that are corners of a rectangle (or other type of polygon). The rectangle may represent the size, shape, orientation, and location of the corresponding physical obstacle in the top-down view. The top-down view may be generated using a rasterizer 210, which may rasterize the 2D coordinates 208 to form the images 214 depicting the top-down view. An example image of a top-down view in which obstacles are depicted as rectangles is shown in FIG. 7A. Each of the images 214 may have a resolution of, for example, 300×300 pixels, or other suitable resolution. Each raster image 214 may be generated by, for each obstacle message 204, drawing each of the 2D points produced by the perspective transform 206 in the image 214. Lines may be drawn between the points of each obstacle to form a rectangle in the image 214, and the rectangle may be filled in with a particular color using a fill operation.

In particular embodiments, the rasterizer 210 may use map data 212 to draw streets and other map features in the images 214. The map data 212 may be a set of structured data representing a map. For example, the rasterizer 210 may query the map data 212 for street lane segments having geographical locations that are within the boundaries of the geographical area represented by image 214. For each lane, the left and right lane boundaries may be drawn, e.g., by drawing points in the image 214. A polygon fill operation may be used to fill in the street with a particular color.

FIG. 2B illustrates an example vehicle system having an example prediction module 215 that predicts appropriate target speeds 236 based on images 214 of the environment. The image-based prediction module 215 can solve the problems associated with determining vehicle speeds by using a speed-predicting neural network 230 that has been trained to predict appropriate vehicle speeds 232 for specified images 214 of the environment. A smoothing filter 234 may process the predicted vehicle speed 232 to generate the vehicle target speed 236. The prediction module 215 may perform the operations of the prediction module 115 as described above with reference to FIG. 1, e.g., generating predicted future environments, in addition to predicting appropriate target speeds 236. Alternatively, the prediction module 215 may be separate from the prediction module 115 and may predict appropriate target speeds 236, in which case both the prediction modules 115, 215 may be present in the navigation pipeline. The prediction module 215 may consume a representation of the present contextual environment from the perception module 110 to generate one or more predictions of the future environment. As an example, given images 214 that represent the contextual environment at time to, the prediction module 215 may output a predicted target speed 236 that is predicted to be an appropriate speed for the vehicle to have at time t₀+1 (e.g., the speed that would be appropriate for the vehicle at 1 second or 1 time step in the future). The prediction module 215 includes one or more machine-learning models, such as the speed-predicting neural network 230, which may be trained based on previously recorded contextual and sensor data.

The image-based speed-predicting neural network 230 may have been trained by, for example, comparing predicted appropriate speeds 232 generated by the neural network 230 to actual speeds at which a vehicle was driven by a human operator (which may be “ground truth” appropriate speeds for training purposes). Differences between the predicted appropriate speeds 232 and the actual speeds may be used to train the neural network 230 using gradient descent or other suitable training techniques. The images 214 may be generated by the image-based perception module 201 as described above with reference to FIG. 2A. The vehicle target speed 236 may be provided to a planning module 120, which may generate a trajectory plan in accordance with the vehicle target speed 236, as described below with reference to FIG. 2D.

In particular embodiments, the image-based speed-predicting neural network 230 may generate a predicted vehicle speed 232 based on the images 214. The predicted vehicle speed 232 may be processed by a smoothing filter 234 to generate a vehicle target speed 236. The smoothing filter 234 may be a low-pass filter or other smoothing filter. The vehicle target speed 236 produced by the smoothing filter 234 may have less variance over time than the predicted vehicle speed 232. For example, the values of the predicted vehicle speed 232 at successive time steps may be 22, 25, 22, 25, and 24 mph. The time steps may occur at intervals of, for example, 300 milliseconds, 500 milliseconds, 1 second, or other suitable interval. An average of the predicted vehicle speeds 232, e.g., 23.6 mph, may be determined over a time period to dampen the variance so that the vehicle's speed does not vary repeatedly between different values, such as 22 and 25, at a high rate, which would be undesirable behavior. The time period over which averages are determined may begin at a specified time t in the past (e.g., 1 second, 5 seconds, 30 seconds, or other suitable time in the past), and end at the current system time to (e.g., the average may be computed over the previous t time units). The smoothing filter 234 may store each of the predicted vehicle speeds 232 from the past t time units in a memory, then discard the oldest speed and re-compute the average when each new predicted vehicle speed 232 is received. In particular embodiments, as an alternative to using a low-pass filter over a time duration, the predicted vehicle speeds 232 generated in the last t time units may be concatenated together and provided as input to the smoothing filter 234.

In particular embodiments, the predicted vehicle speed 232 may be a single value, a bin category (e.g., range) specified as least and greatest values, or a set of bin categories having associated probabilities. A bin category may indicate that any speed in the range is an appropriate speed. For example, the category 15-25 may indicate that any speed between 15 and 25 mph, such as 17.4 mph, is an appropriate speed. The set of bin categories may specify two or more bin categories, and the probability associated with each may be a probability that the associated bin category includes the best estimate of the appropriate speed. Another representation of the predicted vehicle speed 232 may be as a set of values associated with ranges of probabilities that the associated value is the best estimate of the appropriate speed. For example, the speed 23 mph may have a probability greater than 0.8, the speed 24 may have a probability between 0.3 and 0.8, and the speed 25 may have a probability less than 0.8. The bin categories or probabilities may be generated by the image-based speed-predicting neural network 230 in association with the predicted vehicle speeds 232.

In particular embodiments, a speed-predicting neural network 230 may perform particularly well in environments having speed limits or other features similar to the speeds or speed limits or other features in the environment(s) for which it was trained. Particular embodiments may select (e.g., from a database) a neural network 230 (and/or 216) that was trained in environments having speed limits similar to the speeds or speed limits of the current road segment on which the vehicle is located, and use the selected network to predict vehicle speeds 232. Similarly, particular embodiments may use location-based selection of a neural network 230 (and/or 216) that was trained on or near the current geographic location (e.g., road segment, intersection, or area) for which a vehicle speed 232 is to be predicted.

In particular embodiments, the image-based prediction module 215 may receive a current speed limit 260 as input, e.g., from the map data 212. The prediction module 215 may be associated with a “trained for” speed limit 262 that specifies the posted speed limit of one or more road segments on which the neural network 230 was trained (e.g., by a training process). The “trained for” speed limit 262 of the module 215 may be used to determine whether the module 215 was trained for a road segment having the same speed limit (or a similar speed limit as) the road segment on which the vehicle is currently located. If the neural network 230 was trained for a road segment having the same or similar speed limit, then the neural network 230 may be used with the current road segment (e.g., to predict vehicle speeds 232). If not, the vehicle system 200 may search for a different neural network 230 (e.g., in a database of neural networks generated by training processes) having a “trained for” speed limit 262 similar to the speed limit of the current road segment, e.g., similar to the current speed limit 260. Two speed limits may be similar if, for example, they differ by less than a threshold amount. If a neural network 230 is trained on multiple different speed limits, e.g., different road segments having different speed limits, then the “trained for” speed limit 262 may be an average of the multiple different speed limits.

In particular embodiments, the prediction module 215 may alternatively or additionally be associated with a “trained at” location 264 that specifies a location (e.g., latitude and longitude, road segment, or the like) at which the neural network 230 was trained. When a vehicle speed 232 is to be predicted, the vehicle system 200 may search a database or other storage for one or more neural networks 230 that were trained on the same or similar road segment or location, and select one of the neural networks 230 to use for predicting vehicle speed 232. For example, the vehicle system 200 may select the neural network 230 having a “trained at” location 264 closest to the vehicle's current location and/or having a “trained for” speed limit 262 closest to the posted current speed limit 260 associated with the vehicle's location. Two road segments or locations may be similar if, for example, the distance between their geographic locations is less than a threshold amount. If a neural network 230 is trained at multiple different locations, then the “trained at” location 264 may be a location at midpoint between the different locations.

When the neural network 216 and/or 230 is being trained, the “current” road segment is ordinarily the same as the road segment on which the neural network is being trained, so the current speed limit 260 may have the same value as the “trained for” speed limit 262, e.g., the posted speed limit of the road segment on which the vehicle is currently located (during the training process). When the trained neural network 216 and/or 230 is being used (e.g. to perform inferences for a vehicle), the “trained for” speed limit 262 may be the posted speed limit of the road segment on which the neural network 230 was trained, and the current speed limit 260 may be the posted speed limit of the road segment on which the neural network 230 was trained.

In particular embodiments, the speed-predicting neural network 230 may be subject to one or more speed constraints 228 that constrain the predicted vehicle speed 232. The speed constraints 228 may be, e.g., minimum or maximum speed limits. The speed constraints 228 may be upper and/or lower limits on the predicted vehicle speed 232, so that the image-based speed-predicting neural network 230 does not produce predicted vehicle speeds 232 below the lower speed limit or above the upper speed limit. Other constraints may be applied to the output of the image-based speed-predicting neural network 230 as appropriate. In particular embodiments, the image-based speed-predicting neural network 230 may use the map data 212 as an input when generating the predicted vehicle speed 232. For example, the predicted vehicle speed 232 may be based on the current speed limit 260 of the road on which the vehicle is located and/or the “trained for” speed limit 262 of the road(s) on which the speed-predicting neural network 230 was trained (when the neural network 230 is being trained, the current speed limit 260 may be the same as the “trained for” speed limit 260). The speed constraints 228, including the lower and/or upper speed limit, may be based on the “trained for” speed limit 262. For example, the upper speed limit may be the “trained for” speed limit 260, or a value greater than the “trained for” speed limit by a threshold amount. As another example, the lower speed limit may be the “trained for” speed limit 260, or a value less than the “trained for” speed limit by a threshold amount.

FIG. 2C illustrates an example vehicle system 200 having an example prediction module 215 that predicts appropriate target speeds 236 based on images 214 of the environment and predicted future locations of the vehicle and/or agents. The image-based prediction module 215 and smoothing filter 234 are described above with reference to FIG. 2B. FIG. 2C shows additional details of the image-based prediction module 215, including a trajectory-predicting neural network 216 that generate predicted trajectories 218 to be provided as input to the image-based speed-predicting neural network 230. The predicted trajectories 218 may be added to (e.g., rendered in) the images 214 to form augmented images 226, which may be provided to the image-based speed-predicting neural network 230. The augmented images 226 may include one or more previous images 214 generated at previous times, e.g., to provide a representation of changes in position of the vehicle and agents over time as input to the speed-predicting neural network 230. The speed-predicting neural network 230 may generate the predicted vehicle speed 232 based on the augmented images 226, so that the predicted trajectories 218 and/or previous images 214 are used as factors in generating the predicted vehicle speed 232. Alternatively or additionally, the speed-predicting neural network 230 may generate the predicted vehicle speed 232 based on the images 214 (e.g., without predicted trajectories 218 and/or without past images). While the trajectory-predicting neural network 216 and the speed-predicting neural network 230 are shown and described as being separate neural networks, one of ordinary skill in the art would appreciate that the functions of the neural networks 216 and 230 described herein may be performed by a single neural network or by any suitable configuration of one or more machine-learning models, which may be neural networks or other types of machine-learning models. Further, although future trajectories of the vehicle are described as being generated based on predictions, future trajectories may be generated using any suitable technique.

In particular embodiments, as introduced above, the images 214 may be augmented (e.g., processed) to produce augmented images 226. The augmented images 226 may include an image associated with the current (e.g., most recent) time t. The augmented images 226 may also include one or more images from previous times t−1, t−2, . . . t−n. Each of these times may correspond to a different time step of the vehicle system, for example. Each time step may correspond to a different image 214. Receiving an image 214 may correspond to initiation of a new time step, and receiving each successive received image 214 may occur in a corresponding successive time step. The previous images may be previous images 214 that are stored in a memory, for example. The current image (for time t) and one or more previous images (e.g., the 5, 10, or 20 previous images) may be provided to the image-based speed-predicting neural network 230 as a set of augmented images 226. The image-based speed-predicting neural network 230 may generate the predicted vehicle speed 232 based on the set of images 226. The set of images 226 may represent the movement of objects in the environment over time (e.g., the speed and direction of the objects). The images 226 that correspond to previous times t−1, . . . , t−n may be rendered with darker shading to provide cues that the image-based speed-predicting neural network 230 may use to infer the speeds of the objects. This rendering with darker shading may be performed by the image-based prediction module 215 on the augmented images 226, e.g., at each time step. Each of the augmented images 226 may be rendered with a different shade, e.g., with older images being darker than newer images. In particular embodiments, the set of augmented images 226 associated with one or more previous time steps may be provided as an input to the image-based trajectory-predicting neural network 216 for use in generating the predicted trajectories 218 for a current time step. Thus, the predicted trajectories 218 may be based on images 226 from previous times in addition to the images 214 from the current time. That is, for example, at time t, the images the augmented images 226 corresponding to times t−1 through t−n may be provided as input to the trajectory-predicting neural network 216.

In particular embodiments, the predicted appropriate vehicle speed 232 may be based on one or more predicted trajectories 218. The predicted trajectories 218 may be predicted future location points (e.g., trajectory points) of the ego vehicle and/or other agents in the environment. For example, the appropriate speed may be different depending on the direction in which the vehicle moves. Thus, the predicted trajectories 218 of the ego vehicle and/or other agents may be provided to the image-based speed-predicting neural network 230 as input. The image-based prediction module 215 may include an image-based trajectory-predicting neural network 216 that generates the predicted trajectories 218 based on data such as the images 214. The predicted trajectories 218 may be added to the images 214 by a predicted trajectory renderer 224, which may render the prediction trajectories 218 as points or other graphical features on the images 214 to produce the augmented images 226. Alternatively, the predicted trajectories 218 may be provided directly as input to the speed-predicting neural network 230, as shown by the dashed line to the neural network 230. The image-based prediction module 215 may also provide the predicted trajectories 218 as an output for use by other modules such as a planning module 120.

In particular embodiments, the predicted trajectories 218 may be represented as, for example, points in space, such as 2D (x, y) coordinates of points in a top-down view of the environment using an appropriate coordinate system (e.g., pixels, distances from an origin point such as the vehicle's location, latitude/longitude pairs, or other suitable coordinate system). The predicted trajectories 218 may include one or more predicted vehicle locations 220 for the ego vehicle and one or more predicted agent locations 222 for each agent that has been identified in the environment. Each predicted location may represent a point 2D or 3D space, and may correspond to a time in the future. For example, the predicted vehicle locations 220 may include three predicted locations: an (x, y) point for one time unit in the future (shown as t+1, e.g., 1 second in the future), a second (x, y) point for two time units in the future (t+2), and a third (x, y) point for three time units in the future (t+3). There may be between 1 and a number n predicted locations for the vehicle (e.g., associated with times t+1 through t+n). Similarly, the predicted agent locations 222 may include one or more predicted locations for each identified agent in the environment. Although the predicted trajectories 218 are described as including points that correspond to times, the predicted trajectories 218 may be represented using any suitable information. For example, the points 220, 222 in the trajectories need not be associated with times.

In particular embodiments, the predicted trajectory renderer 224 may render a point (e.g., one or more adjacent pixels) or other graphical feature in a designated color that contrasts with the background colors adjacent to the point's location in the image. Each rendered point represents a corresponding predicted location. For example, at a time t, the (x, y) coordinates of each predicted location associated with times t through t+n may be used to set the color of a corresponding pixel of the image associated with time t in the augmented images 226 (after transforming the (x, y) coordinates of the predicted location to the coordinate system of the images 226, if appropriate). Thus, one or more of the predicted trajectories 218 (e.g., for times t+1 through t+n) may be rendered as points on the augmented image associated with time t. In particular embodiments, when the vehicle system advances to the next time step, and the image for time t moves to time t−1, the rendered representations of the predicted trajectories 218 may remain on the image or may be removed from the image. The image-based speed-predicting neural network 230 may then include the predicted trajectories 218 in the determination of the predicted vehicle speed 232.

FIG. 2D illustrates an example vehicle system 200 having a planning module 240 that generates trajectory plans based on predicted target speeds 220. The planning module 240 may correspond to the planning module 120 described above with reference to FIG. 1. The planning module 240 may be used with image-based predictions (e.g., an image-based perception module 201 and image-based prediction module 215) or with point-cloud-based predictions (e.g., a point-based perception module 401 and a point-based prediction module 415). Other suitable representations of the environment may be used in other embodiments. The prediction module 215 or 422 may generate data for use by the planning model 240, including a vehicle target speed 236, predicted trajectories 218, and one or more optional other signals 238.

In particular embodiments, the planning module 240 may receive one or more signals 242 from the prediction module 215 or 422 or other source, and may generate a corresponding trajectory plan 248. The planning module 240 may use plan generator 244 to generate candidate trajectory plans, and may use a cost function 246 to calculate scores for the candidate trajectory plans. The planning module 240 may select the candidate plan having the highest score as the trajectory plan 248 to be used by the vehicle. The cost function 246 may evaluate the candidate trajectory plans using scoring criteria. The scoring criteria may include travel distance or time, fuel economy, changes to the estimated time of arrival at the destination, passenger comfort, proximity to other vehicles, the confidence score associated with the predicted contextual representation, likelihood of collision, etc. The scoring criteria may be evaluated based on the values of the signals 242.

In particular embodiments, one or more of the scoring criteria may involve comparison of an attribute of a candidate trajectory plan, such as a planned speed, to a signal 242. The comparison may be performed by the cost function 246, which may calculate a score for each candidate trajectory plan based on a difference between an attribute of the candidate trajectory plan and a value of a signal 242. The planning module 240 may calculate the score of a candidate trajectory plan as a sum of individual scores, where each individual score is for a particular one of the scoring criteria. Thus, each of the individual scores represents a term in the sum that forms the score for the candidate trajectory plan. The planning module 240 may select the candidate trajectory plan that has the highest total score as the trajectory plan 248 to be used by the vehicle.

For example, for the vehicle target speed 236 signal, the cost function 246 may generate a score based on the difference between a planned speed associated with the candidate trajectory plan and the vehicle target speed 236. Since this difference is one of several terms in the sum that forms the total score for the candidate trajectory plan, the selected trajectory plan 248 has speed(s) as close to the vehicle target speed 236 as feasible while taking the other scoring criteria into account. Another one of the scoring criteria may be a difference between the planned speed associated with the candidate trajectory plan and the speed limit of the road on which the vehicle is located (the speed limit may be one of the signals 242). The trajectory plan 248 having the highest score may thus incorporate the vehicle target speed 236 while still obeying the speed limit. The cost function 246 may have terms that reduce the score for plans that exceed the speed limit or do not reach the speed limit. These terms may be added to terms for other signals 242 by the cost function 246 when computing the score for the plan.

In particular embodiments, the plan generator 244 may determine one or more points 252 of the trajectory plan 248. The points 252 may form a navigation path for the vehicle. The points 252 may be successive locations on the trajectory. The plan generator 244 may also determine one or more speeds 250, which may include a constant speed 254 for the vehicle to use for the trajectory plan 248, or multiple different speeds 254 for the vehicle to use at the different corresponding points 252. Three points 252A, 252B, and 252N are shown in the trajectory plan 248. One or more speeds 250 may be associated with the trajectory plan 248. If the trajectory plan 248 is associated with a constant speed 253, each of the points 252 may be associated with the same constant speed 253. Alternatively, each of the points 252 may be associated with a corresponding speed 254, in which case each point 252 may be associated with a different speed value (though one or more of the speeds 254 may have the same values). Three speeds 254A, 254B, and 254N are shown, which are associated with the respective points 252A, 252B, 252N. The trajectory plan 248 and/or the speeds 250 may correspond to driving operations, such as operations that specify amounts of acceleration, deceleration, braking, steering angle, and so on, to be performed by the vehicle. The driving operations may be determined by the planning module 240 or the control module 125 based on the trajectory plan 248 and speeds 250.

In particular embodiments, the trajectory plan 248 may be provided to a control module 125 as input, and the control module 125 may cause the vehicle to move in accordance with the trajectory plan 248. The control module 125 may determine the specific commands to be issued to the actuators of the vehicle to carry out the trajectory plan 248.

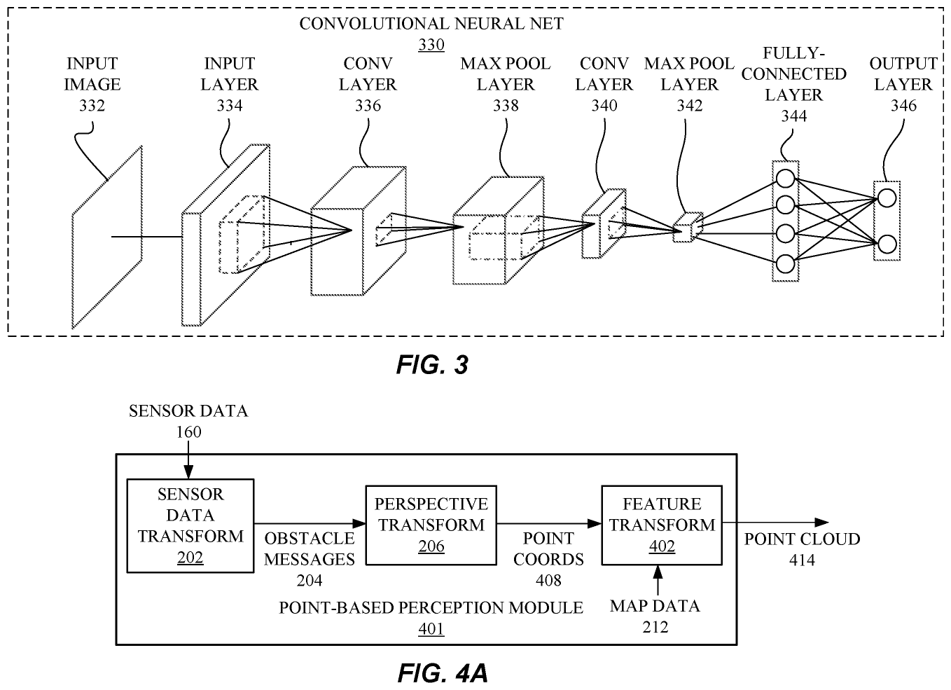

FIG. 3 illustrates an example convolutional neural network (CNN) 330. The CNN 330 processes one or more input images 332 and produces activations in an output layer 346 that correspond to predictions. The CNN 330 may be understood as a type of neural network that uses convolution operations instead of matrix multiplication in at least one of its layers. The convolution operation is a sliding dot-product used to combine multiple input values (also referred to as neurons) in a sliding window-like area of a convolutional layer's input to form fewer output values. Each convolutional layer may have an activation function such as RELU or the like. Each layer of the CNN 330 may transform a matrix of input values to a smaller matrix of output values. The CNN 330 includes an input layer 334, which receives the input images 332, a first convolutional layer 336, which performs convolutions on the input layer 334, a first max pool layer 338, which performs max pool operations that reduce the dimensions of the output of the first convolutional layer 336 by selecting maximum values from clusters of values, a second convolutional layer 340, which performs convolutions on the output of the max pool layer 338, a second max pool layer 342, which performs max pool operations on the output of the second convolutional layer 340, a fully-connected layer 344 which receives the output of the second max pool layer 342 and produces an output that includes a number (k) values, shown as an output layer 346. The values in the output layer 346 may correspond to a prediction, such as a predicted speed 232, generated based on the input images 332. Although the example CNN 330 is described as having particular layers and operations, other examples of the CNN 330 may be convolutional neural networks that have other suitable layers and perform other suitable operations.

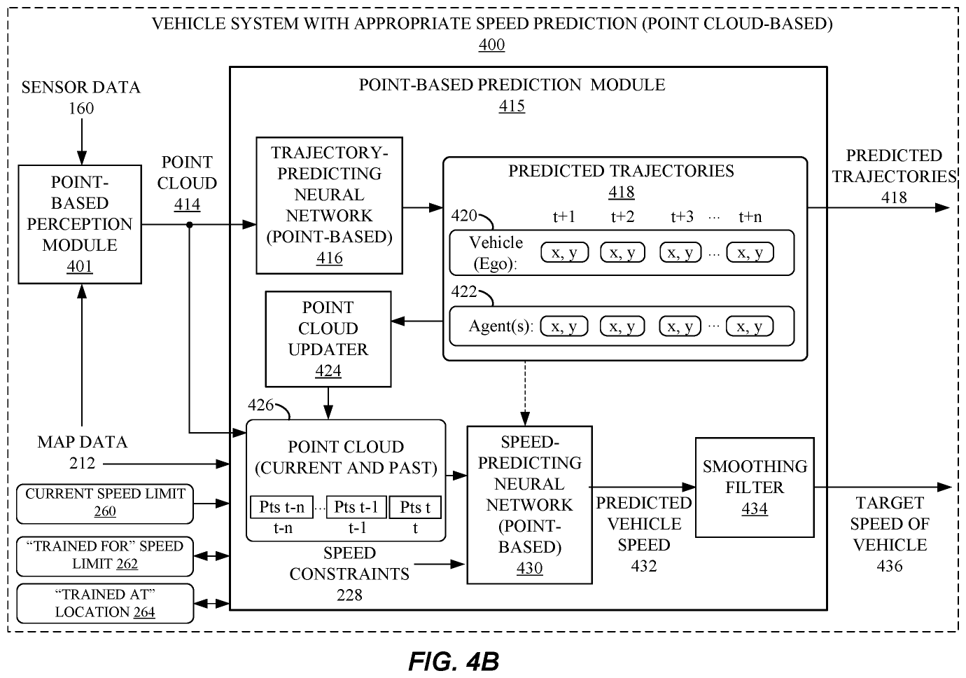

FIG. 4A illustrates an example point-based perception module 401. The point-based perception module 401 may be used as an alternative or in addition to the image-based perception module 201. In particular embodiments, the point-based perception module 401 may generate a point cloud 414 that represents the environment instead of an image 214. Point clouds 414 may use less storage space than images 214. Further, using point clouds in machine-learning models may be more computationally efficient than using images 214. The perception module 401 may use sensor data 160 to construct the point cloud 414. The perception module 401 may include a sensor data transform 202, which may transform the sensor data 160 to obstacle messages 204, a perspective transform 206, which may transform obstacle messages 204 to point coordinates 408, and a feature transform 402, which may transform the point coordinates 408 and map data 212 to form the point cloud 414. Thus, in comparison to the image-based perception module 201, the point-based perception model 401 may generate the point cloud 414 instead of the images 214. Predictions may then be made using a point-based neural network (PBNN) instead of a CNN 330.

In particular embodiments, in a point cloud 414, a vehicle environment, including objects such as obstacles, may be represented as a set of points. For example, there may be points that represent the orientation, location, and shape of each car, pedestrian, and street boundary near the vehicle. Each point may have coordinates (e.g., x, y or x, y, z), and one or more associated point-feature values. Information, such as a classification of the object represented by the points as a car, pedestrian, or street boundary, may be encoded in the point-feature values associated with the points. The PBNN may generate a prediction 410 for each one of the objects represented in the point cloud 414. Each prediction 410 may be, for example, predicted future locations, of the corresponding object. The point cloud 414 may be updated over time based on updated sensor data 160, and updated predictions may be generated over time by the PBNN based on updates to point cloud 414 that reflect the changing environment.

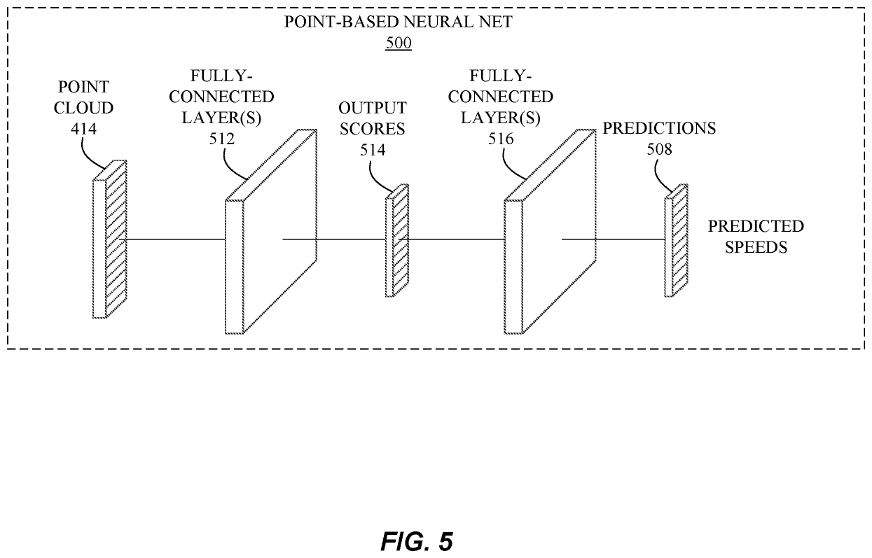

Although the examples described herein refer to point clouds 414 having top-down views, in other examples point clouds 414 may represent different views in addition to or instead of the top-down views. The point coordinates 408 may be 2D coordinates in a two-dimensional view, which may be included in a point cloud 414 as described below. Alternatively or additionally, the perspective transform 206 may convert the obstacle message (e.g., the bounding box coordinates or other suitable coordinates) to points in views other than top-down views, such as front, side, or rear views (e.g., from the point-of-view of front, side, or rear cameras on the vehicle). The point coordinates 408 may be 2D or 3D coordinates in these other views. For example, the other views may include a two-dimensional view that represent a three-dimensional scene, in which case the coordinates 408 may be 2D coordinates, e.g., (x, y) pairs. Alternatively or additionally, the other views may include a three-dimensional view that represents a three-dimensional scene, in which case the coordinates in the point cloud 414 may be 3D coordinates, e.g., (x, y, z) tuples. The perspective transform may convert three-dimensional bounding-box coordinates from the obstacle messages 204 to three-dimensional points 408 (e.g., in a different coordinate system than the bounding boxes, and/or with different units, a different origin, or the like). If the point coordinates 408 represent three-dimensional points, the perspective transform 206 may be optional, and the points 408 may include the bounding-box coordinates from the obstacle messages 204. The 3D coordinates may be processed by a point-based neural network to make predictions. The machine-learning model may be, e.g., a neural network 406 having one or more fully-connected layers, such as a PointNet or the like, as described below with reference to FIG. 5.

A feature transform 402 may transform features of each object representation, such as the obstacle's classification, heading, identifier, and so on, from each obstacle message 204, to corresponding values in the point cloud 404. For example, the feature transform 402 may store the object's classification as a point-feature value associated with the points. The point coordinates 408 and their associated point-feature values may be added to a list of points that represents the point cloud 414. In particular embodiments, the feature transform 402 may store additional information in the point-feature values associated with the points. Geographic and/or street map features that represent physical objects, such as streets, in the vehicle's environment may be identified in map data 212 retrieved from a map database. The vehicle system may transform the coordinates of each map feature to one or more points and add each point to the point cloud 414. For example, the locations of street lane boundaries in the environment, and information indicating whether the points of a lane boundary are relative to the center of the lane, the left lane, or the right lane, may be encoded as point-feature values associated with the points of the lane. The distances from objects to lane boundaries, positions and orientations of objects relative to other objects, object trajectory, and object speed, may also be stored as point-feature values for each object.

FIG. 4B illustrates an example vehicle system 400 having an example prediction module 415 that predicts appropriate target speeds 436 based on point clouds 414 that represent the environment. The point-based prediction module 415 is analogous to the image-based prediction module 215 shown in FIG. 2B, but uses point clouds instead of images to represent the environment. The point-based perception module 415 may use sensor data 160 to construct a point cloud 414 containing a set of points that represent the vehicle's environment, and use a point-based speed-predicting neural network 430 to generate a predicted vehicle speed 432. The point-based speed-predicting neural network 430 may be processed by a smoothing filter 434 to generate a target speed of vehicle 436. In particular embodiments, the point-based speed-predicting neural network 430 may be subject to one or more speed constraints 228 that constrain the predicted vehicle speed 432 to be within specified limits. The point-based prediction module 415 can solve the problems associated with determining vehicle speeds by using a speed-predicting neural network 430 that has been trained to predict appropriate speeds for specified point clouds 414 that represent the environment.

In particular embodiments, one or more point clouds 414 may be generated by the point-based perception module 401 based on the sensor data 160. Point-based neural networks (PBNNs) 416, 430 may be used to generate predictions based on the point clouds 414. In the point cloud 414, the vehicle environment, including objects such as obstacles, agents, and the vehicle itself, may be represented as points. For example, there may be points that represent the orientation, location, color, and/or shape of each object and street boundary near the vehicle. Each point may have x and y coordinates, or x, y, and z coordinates, and one or more point-feature values. Information, such as classifications of the objects represented by the points as a car, pedestrian, or street boundary, may be encoded in the point-feature values associated with the points. Each PBNN 416, 430 may generate predictions based on one or more of the objects represented in the point cloud 414. The predictions may be, for example, predicted trajectories or predicted speeds of the vehicle. Each PBNN 416, 430 may be a neural network of fully-connected layers such PointNet or the like.

In particular embodiments, the perception module 415 may use a point-based trajectory-predicting neural network 416 to generate predicted trajectories 418 based on the point cloud 414. The predicted trajectories 418 may include predicted vehicle locations 420 and predicted agent locations 422 for one or more future time steps. The predicted trajectories 418 may be added to an augmented point cloud 426 by a point cloud updater 424, which may, e.g., copy or otherwise transfer the coordinates of the predicted trajectories 418 and the coordinates of the points in the point cloud 414 to the augmented point cloud 426. Thus, the augmented point cloud 426 may include the point cloud 414. The augmented point cloud 426 may be provided to the point-based speed-predicting neural network 430 as input. The point-based trajectory-predicting neural network 416 and point-based speed-predicting neural network 430 are analogous to the image-based trajectory-predicting neural network 216 and image-based speed-predicting neural network 230, but may be trained and used to make predictions based on point clouds 414 instead of images 214. Alternatively, the point cloud 414 may be provided as input to the point-based speed-predicting neural network 430 without predicted trajectories 418, similarly to the example of FIG. 2B.

In particular embodiments, the augmented point cloud 426 may include one or more points from previous point clouds 414 generated at previous times. Including points from previous point clouds 414 may provide a representation of changes in position of the vehicle and agents over time as input to the augmented point cloud 426. The point-based speed-predicting neural network 430 may generate the predicted vehicle speed 432 based on the augmented point cloud 426, so that the predicted trajectories 418 and/or previous images 414 are used as factors in generating the predicted vehicle speed 432. The point cloud 414 may be combined with previous point cloud(s) 414 received at previous times. The augmented point cloud 426 may include the point cloud 414, which is received at time t and shown as a box “Pts t” in the augmented point cloud 426. A previous set of points, which may be from the point cloud 414 received at time t−1, is shown as “Pts t−1.” The time t−1 may be, e.g., 1 time unit in the past, where a time unit may be, e.g., 1 second, 2 seconds, 5 seconds, or other suitable value. Each time unit may correspond to a time step, and an updated point cloud 414 may be received at each time step. Each point in the point cloud 414 may be associated with a time-related value related to the time at which the point (or the point cloud 414) was generated or received. For example, each point in “Pts t” may be associated with the time t, and each point in “Pts t−1” may be associated with the time t−1. The association may be stored individually for each point, e.g., by including the time value (t) in a tuple that represents the point, or by setting a color of the point to a value corresponding to the time value t (e.g., older points having lighter shades of color). If time values t are associated with individual points, then each point in the current and past point clouds of the augmented point cloud 426 may be stored in a single common set of points. Alternatively, the point clouds for different times may be stored as separate sets, and the time value t for the points in the set may be associated with the set instead of with the individual points.

The augmented point cloud 426 may include additional sets of points from previous times, back to an earliest set of points shown as “Pts t−n” that corresponds to a time t−n (e.g., n time units in the past). Each updated point cloud 414 may include one or more points that are different from the previous point cloud 414. Each set of points from a different time that is stored in the point-based trajectory-predicting neural network 416 may include some or all of the points from that point cloud 414 that corresponds to that time. In particular embodiments, each set of points, e.g., “Points t−1” for time t−1, may include points that are different from points in the next most recent adjacent set of points, e.g., “Points t” for time t. The number of previous times for which points are stored n may be limited by a threshold number, e.g., 2, 5, 8, 10, or other suitable number, to limit the size of the augmented point cloud 426 and/or limit the amount of processing performed on the augmented point cloud 426. In particular embodiments, the augmented point cloud 426 may be provided as an input to the trajectory-predicting neural network 416 for use in generating the predicted trajectories 418. Thus, the predicted trajectories 418 may be based on points from previous times in addition to the point cloud 414 from the current time. In other words, one or more previous point clouds 414 may be provided to the trajectory-predicting neural network 416 as input. For example, at time t, the points in the augmented point cloud 426 corresponding to times t−1 through t−n may be provided as input to the trajectory-predicting neural network 416.

The point-based speed-predicting neural network 430 may have been trained by, for example, comparing predicted appropriate speeds 432 generated by the point-based speed-predicting neural network 430 to actual speeds at which a vehicle was driven by a human operator (which may be “ground truth” appropriate speeds for training purposes). Differences between the predicted appropriate speeds 432 and the actual speeds may be used to train the point-based speed-predicting neural network 430, e.g., using gradient descent or other suitable training techniques.

In particular embodiments, a vehicle system 400 that uses a point-cloud representation of the vehicle's environment, as described herein, can be substantially more efficient than a system that uses images to represent the environment. Point clouds can use substantially less memory than image representations of scenes. Point clouds can include points that represent obstacles but need not include points for areas of the environment that have little relevance to the subsequent planning stage, such as buildings, sidewalks, the sky, and so on. In a point cloud, an irrelevant area need not consume storage space, since the point cloud need not contain any points for the irrelevant area. As described above, a 300×300 pixel image of a scene may consume one megabyte of memory. By comparison, a 300×300 point representation a scene having 50 obstacles may use four points per obstacle. If each point consumes 128 bytes, then the scene may be represented using 26 kilobytes. Thus, using a PBNN can result in substantially-reduced processor and storage resource usage by the vehicle. These computational resources may then be used for other purposes, such as increasing sensor resolution and prediction accuracy.

FIG. 5 illustrates an example point-based neural network (PBNN) 500. The PBNN 500 may receive the point cloud 404 as input, and may produce, as output, predictions 508 (e.g., activations) that correspond to predicted speeds. The speed-predicting neural network 430 of FIG. 4B may be a PBNN 500. The predicted speeds may be appropriate speeds of the objects whose points are specified in the point cloud 414. The PBNN 500 includes at least one fully-connected layer. The fully-connected layer(s) may receive the point cloud 414 as input and generate the predictions 508. In the example of FIG. 5, the PBNN 500 includes one or more first fully-connected layers 512, which may receive the point cloud 414 as input and generate output scores 514, and one or more second fully-connected layers 516, which may receive the output scores 514 as input and generate the predictions 508. The point-based neural network 500 may be, e.g., PointNet or the like.

FIG. 6 illustrates an example urban vehicle environment 600. The urban environment 600 includes a city street that has a posted speed limit of 35 mph. Several objects are present in the urban environment 600, including two cars 602, 610 on the city street, lane lines 604, 606, buildings 608, a traffic light 612, and a pedestrian 614 located on a cross street. The urban environment 600 may be captured by cameras of a vehicle and provided to an image-based perception module 201 or a point-based perception module 401 as sensor data 160. Bounding boxes, which may be identified by the image-based perception module 201 or point-based perception module 401, are shown as dashed rectangles. The bounding boxes include a bounding box 603 around the car 602, a bounding box 611 around the car 610, and a bounding box 615 around the pedestrian 614.

FIG. 7A illustrates an example top view image 700 of an urban vehicle environment. The urban top view 700 may be generated by an image-based perception module 201 based on the urban environment 600, and may correspond to an image 214. The urban top view 700 is associated with a time T₀, e.g., the urban top view 700 may be an image captured at a particular time T₀. The urban top view 700 includes representations of the objects from the urban environment 600. The representations include cars 702, 710 that correspond to the cars 602, 610, lane lines 704, 706 that correspond to the lane lines 604, 606, buildings 708 that correspond to the buildings 608, a traffic light 712 that corresponds to the traffic light 612, and a pedestrian 714 that corresponds to the pedestrian 614. Also shown in FIG. 7 is a vehicle 716 that represents a location and orientation of an ego vehicle, which is on the city street behind the car 702.

The speed-predicting neural network 230 may generate a predicted vehicle speed 232 of 32 mph for the vehicle 716 based on the urban top view 700. In particular embodiments, as an image-based neural network, the speed-predicting neural network 230 may use the graphical features of the urban top view 700 to predict the vehicle speed 232. For example, correlations established in the training of the neural network 230 between graphical features images of top views of environments and predicted vehicle speeds may be used by the neural network 230 to identify the speed (or range of speeds) that correlates with the specific urban top view 700. The graphical features used as input by the neural network 230 to make this inference may include the locations and colors of pixels in the urban top view 700. For example, the locations in the urban top view 700 of the pixels that depict the cars 702, 710, the lane lines 704, 706, the buildings 708, the traffic light 712, and the pedestrian 714 may be used as input by the neural network 230 to infer the speed that correlates with the urban top view 700 according to the neural network's training. Multiple images of the urban top view 700 may be provided as input to the neural network for the inference, e.g., in the form of multiple frames, in which case the neural network 230 may infer the speed based on changes in the positions of the pixels that represent the features shown in the urban top view 700. The changes in positions may be proportional to speeds of the objects represented in the images, so the predicted speed may be based on the speeds of the objects.

A point cloud 414 may alternatively be generated by a point-based perception module 401 based on the urban environment 600. The point cloud be, for example, a top view or front view, and may include points (not shown) that correspond to the locations of the objects in the urban environment 600.

FIGS. 7B and 7C illustrate example top view images 720 and 722 of an urban vehicle environment captured at past times. As shown in FIG. 7B, the urban top view 720 includes representations of the cars 702, 710 and other objects that are not labeled with reference numbers, including other cars, lane lines buildings, and a traffic light. The urban top view 720 is associated with a time T₀−1, which indicates that the urban top view 720 is older (by 1 time unit) than the urban top view 700. Since top view image 720 is older than top view image 700, the objects shown in the top view 720 (and their pixels) are at different locations, which are the locations at which the objects were located at time T₀−1. Since the vehicle 716 is moving to the north as time elapses, the stationary objects such as the buildings and traffic light in the earlier top view 722 appear to have moved to the north in the top view 720 relative to the newer top view 700. The distance by which the objects have moved to the north is related to the speed at which they appear to be moving. For example, an object's speed may be proportional to the distance it has moved (e.g., 45 feet) divided by the time elapsed between frames (e.g., 1 second), which is a speed of approximately 40 feet per second (31 mph). Since the vehicle 716 is actually moving, and the buildings and traffic light are stationary, the speed of the vehicle 716 is 40 feet per second. Moving objects such as the cars 702, 710, which are moving relative to the buildings, are moving at speeds closer to the speed of the vehicle 716, and so do not move as quickly relative to the vehicle 716 between the top views 700 and 720. The cars 702, 710 have moved by a smaller distance in the top view 720 relative to the top view 700, so their speeds are closer to the speed of the vehicle 716. The machine-learning models in prediction module 215 may infer the speeds of these objects (e.g., the cars 702, 710, the buildings, and the traffic light) by receiving and processing the images of the top views 720, 700 in succession (e.g., as two adjacent images in the augmented images 226). The speed-predicting neural network 230 may generate a predicted vehicle speed 232 of 31 mph for the vehicle 716 based on the urban top view 720. Alternatively or additionally, the machine-learning models in point-based prediction module 415 may similarly capture the speeds of movement of these objects and generate a predicted vehicle speed 432 of 41 mph for the vehicle 716 based on a point representation of the urban top view 720.

In particular embodiments, as an image-based neural network, the neural network 230 may use the graphical features of the urban top view 720, such as the locations of the pixels that form the lines and rectangles shown in the top view 720, to predict the vehicle speed 232. When two images 720, 700 from successive times (e.g., at intervals of 1 second) are provided as input to the machine-learning models of the image-based prediction module 215 (such as the image-based speed-predicting neural network 230 and the image-based trajectory-predicting neural network 216), the machine-learning models may include the rate of movement of the graphical features of the images in their predictions (or training, when the models are being trained) because of the changes in locations of the features between the two images. Thus the predicted vehicle speed 232 may be based on the rate of movement of the vehicle and/or of other objects in the augmented images 226.

Further movement of the vehicle 716 is shown in FIG. 7C. FIG. 7C shows an example urban top view 722 associated with a time T₀−2, which indicates that the urban top view 722 is older (by 1 time unit) than the urban top view 720. The buildings and traffic light have accordingly moved further to the north. The cars 702, 710, which are moving relative to the vehicle 716, have moved to the north by shorter distances than the buildings have moved, because the cars 702, 710 are moving at similar speeds to the vehicle 716 (and in the same direction as the vehicle 716). The speed-predicting neural network 230 may predict the speed of the vehicle 716 based on the top view 722 based on the locations of features in each image and the changes in locations of the features between different images as described above. As the features of the top view 722 resemble those of the top views 700 and 720, and the distances by which the features moved between the different top views 700, 720, 722 are similar, the speed-predicting neural network 230 may generate a similar predicted vehicle speed 232 of 30 mph for the vehicle 716 based on the urban top view 722.

FIG. 8 illustrates an example residential vehicle environment 800. The residential vehicle environment 800 includes a residential street that has a posted speed limit of 35 mph. Several objects are present in the residential environment 800, including four cars 802, 804, 806, 824 on the residential street, trees 808, 822, 832, signs 812, 818, houses 810, 820, 834, lane line 814, bush 816, and poles 826, 828, 830. The residential environment 800 may be captured by cameras of a vehicle and provided to an image-based perception module 201 or a point-based perception module 401 as sensor data 160. Although the posted speed limit in the residential environment 800 is the same as in the urban environment 600, the objects and their positions are different from the urban environment 600. A human driver may observe that this arrangement is a residential environment and drive at speeds lower than 35 mph. For example, 20 mph or 25 mph (or the range 20-25 mph) may be more appropriate speeds for the residential environment 800 than 35 mph. However, identifying this difference in appropriate speed between the urban environment 600 and the residential environment 800 is difficult for existing vehicle systems, as there is not a particular feature or object in either of the environments 600, 800 that may be detected by an existing vehicle system and used to determine that an appropriate speed for the urban environment 600 may be 35 mph, but an appropriate speed for the residential environment 800 may be 20 or 25 mph. The individual objects in the residential environment 800, such as the tree 808, the house 820, or other objects, may be present in an environment in which the appropriate speed is 35 mph. However, the combination of objects and their locations in the residential environment 800 indicates that the safe speed is lower, e.g., 20-25 mph. The image-based prediction module 215 (or the point-based prediction model 415) may determine that this combination of objects and locations corresponds to an appropriate speed of 20-25 mph based on training that has established neural-network configurations (e.g., weight values) that correlate the features of the urban environment 600 with an appropriate speed of 35 mph and the residential environment 800 with an appropriate speed of 20-25 mph. When the prediction model 215 (or 415) has been trained on a sufficient number of images that included objects having shapes and locations similar to those in the urban environment 600 and were correlated with a ground truth appropriate speed of 35, then the prediction model 215 may determine that the appropriate speed for similar environments is 35.

In particular embodiments, the appropriate speed determination techniques disclosed herein may be extended to images of other environments. For example, images of intersections having many pedestrians may be correlated with relatively low appropriate speeds, such as 10 mph. Images of empty roads surrounded by flat open spaces may be correlated with relatively high appropriate speeds (subject to posted speed limit constraints), such as 65 mph. Any suitable number of different types of environments may be included in the training of the prediction models 215 or 415. The trained models may then determine the appropriate speed for a previously-unseen environment that has similarities in object shapes and locations by identifying analogous environments from the model's training that have similarities to the previously-unseen environment. The appropriate speed for the previously-unseen environment may then be determined based on a correlation in the model between the analogous environments and an appropriate speed from the model's training.

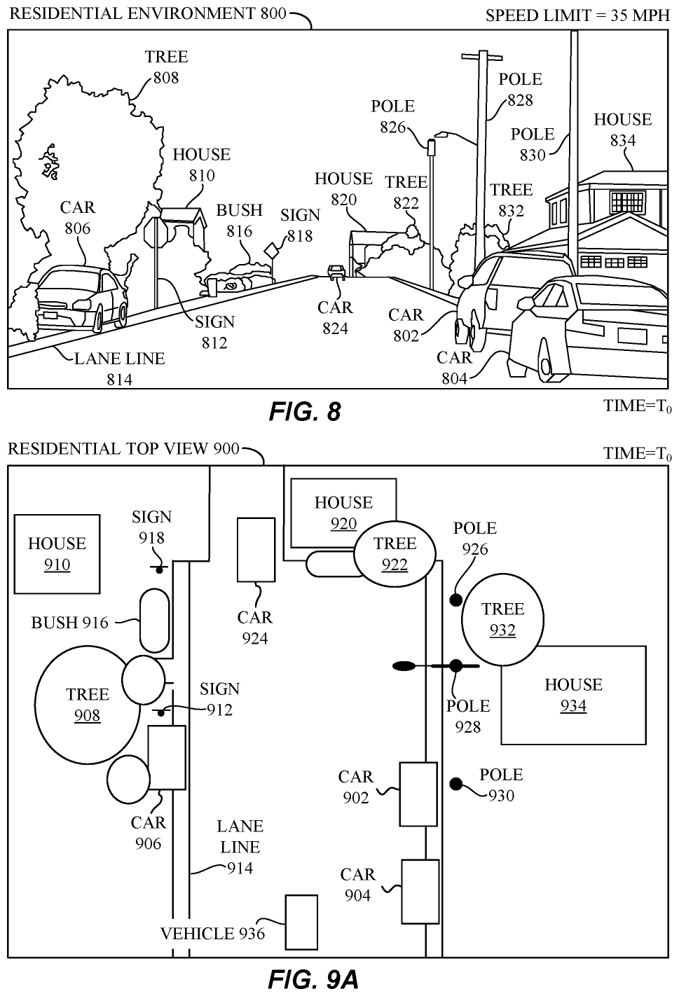

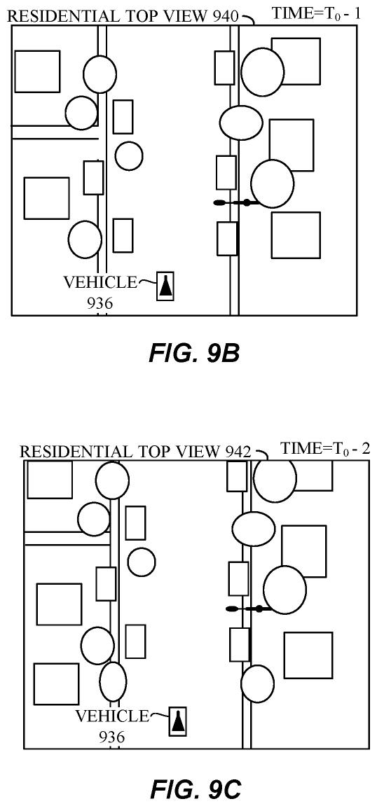

FIG. 9A illustrates an example top view image 900 of a residential vehicle environment. The residential top view 900 may be generated by an image-based perception module 201 based on the residential environment 800, and may correspond to an image 214. The residential top view 900 is associated with a time T₀, e.g., the residential top view 900 may be an image captured at a particular time T₀. The residential top view 900 includes representations of the objects from the residential environment 800. The representations include parked cars 902, 904, 906, 924 that correspond to the cars 802, 804, 806, 824, trees 908, 922, 932 that correspond to the trees 808, 822, 832, signs 912, 918 that correspond to the signs 812, 818, houses 910, 920, 934 that correspond to the houses 810, 820, 834, lane line 914 that corresponds to the lane line 814, a bush 916 that corresponds to the bush 816, and poles 826, 828, 830 that correspond to the poles 826, 828, 830.

In particular embodiments, the speed-predicting neural network 230 may generate a predicted vehicle speed 232 of 20 mph for the vehicle 936 based on the residential top view 900. The neural network 230 can distinguish the residential top view 900 from the urban top view 700 because of the differences in graphical features between the two views. In the residential top view 900, the objects are closer together than the urban top view 700, and the residential top view 900 has objects of different types not in the urban top view 700, such as trees and houses. The trees and houses are located near the lane lines that separate the street from the houses. This combination of different locations and different types is sufficiently different from the arrangement in the urban top view 700. The neural network 230 is thus able to determine, based on its training, that the residential top view 900 corresponds to an appropriate speed of 20 mph.

In particular embodiments, as an image-based neural network, the neural network 230 may use the graphical features of the residential top view 900 to predict the vehicle speed 232. For example, correlations established in the training of the neural network 230 between graphical features images of top views of environments and predicted vehicle speeds may be used by the neural network 230 to identify the speed (or range of speeds) that correlates with the specific residential top view 900. The graphical features used as input by the neural network 230 to make this inference may include the locations and colors of pixels in the residential top view 900. For example, the locations in the residential top view 900 of the pixels that depict the cars 902, 904, 906, 924, the lane line 914, the houses 910, 920, 934, the signs 918, 912, and the pedestrian 914 trees 808, 822, 832 may be used as input by the neural network 230 to infer the speed that correlates with the residential top view 900 according to the neural network's training. Multiple images of the residential top view 900 may be provided as input to the neural network for the inference, e.g., in the form of multiple frames, in which case the neural network 230 may infer the speed based on changes in the positions of the pixels that represent the features shown in the residential top view 900. The changes in positions may be proportional to speeds of the objects represented in the images, so the predicted speed may be based on the speeds of the objects.

A point cloud may alternatively be generated by a point-based perception module 401 based on the residential environment 800. The point cloud be, for example, a top view or front view, and may include points that correspond to the locations of the objects in the residential environment 800.

FIGS. 9B and 9C illustrate example top view images 940 and 942 of a residential vehicle environment captured at past times. As shown in FIG. 9B, the residential top view 940 includes representations of the cars 902, 904, 914 and other objects not labeled with reference numbers, including other cars, lane lines buildings, and a traffic light. The residential top view 940 is associated with a time T₀−1, which indicates that the residential top view 940 is older (by 1 time unit) than the residential top view 900. Since top view image 940 is older than top view image 900, the objects shown in the top view 940 (and their pixels) are at different locations, which are the locations at which the objects were located at time T₀−1. Since the vehicle 916 is moving to the north as time elapses, the stationary objects such as the buildings and traffic light in the earlier top view 942 appear to have moved to the north in the top view 940 relative to the newer top view 900. The distance by which the objects have moved to the north is related to the speed at which they appear to be moving (e.g., their speed is proportional to the distance they have moved (e.g., 45 feet) divided by the time elapsed between frames (e.g., 1 second), which is a speed of approximately 30 feet per second (20 mph) in this example. Since the vehicle 916 is actually moving, and the buildings and traffic light are stationary, the speed of the vehicle 916 is 20 feet per second.

In particular embodiments, as described above with reference to FIGS. 7A-7C, as an image-based neural network, the neural network 230 may use the graphical features of the residential top view 940, such as the locations of the pixels that form the lines and rectangles shown in the top view 940, to predict the vehicle speed 232. When two images 940, 900 from successive times (e.g., at intervals of 1 second) are provided as input to the machine-learning models of the image-based prediction module 215 (such as the image-based speed-predicting neural network 230 and the image-based trajectory-predicting neural network 216), the machine-learning models may include the rate of movement of the graphical features of the images in their predictions (or training, when the models are being trained) because of the changes in locations of the features between the two images. Thus the predicted vehicle speed 232 may be based on the rate of movement of the vehicle and/or of other objects in the augmented images 226.

Further movement of the vehicle 916 is shown in FIG. 9C. FIG. 9C shows an example residential top view 942 associated with a time T₀−2, which indicates that the residential top view 942 is older (by one time unit) than the residential top view 940. The houses, trees, parked cars, and pole have accordingly moved further to the north. The speed-predicting neural network 230 may predict the speed of the vehicle 916 based on the top view 942 based on the locations of features in each image and the changes in locations of the features between different images as described above. As the features of the top view 942 resemble those of the top views 900 and 940, and the distances by which the features moved between the different top views 900, 940, 942 are similar, the speed-predicting neural network 230 may generate a similar predicted vehicle speed 232 of 20 mph for the vehicle 916 based on the residential top view 942.

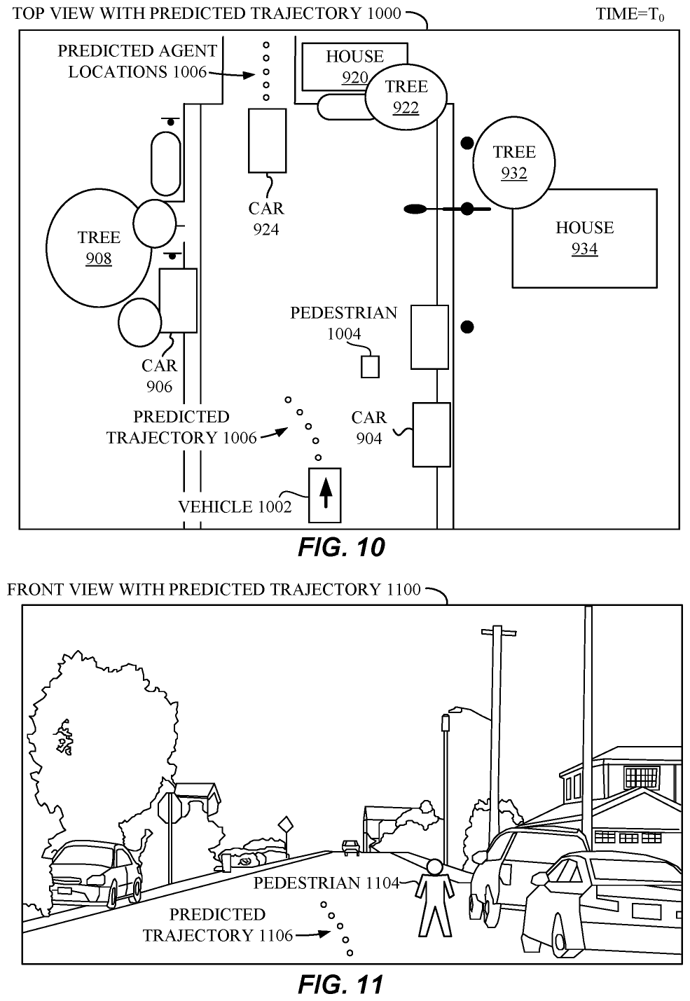

FIG. 10 illustrates an example top view 1000 that includes predicted vehicle trajectory 1006. The top view 100 may be a residential top view 900 to which predicted vehicle trajectory 1006 has been added. The top view 1000 may be one of the augmented images 226 that has been augmented by the predicted trajectory renderer 224 with predicted vehicle trajectory 1006 that is based on predicted trajectories 218. The predicted vehicle trajectory 1006 may be rendered as one or more circles, points, or other suitable shapes (e.g., a straight or curved line) at locations corresponding to the predicted future trajectory 218 of the vehicle. Each of the predicted vehicle locations 1006 may correspond to a time in the future. The predicted vehicle trajectory 1006 forms a path through which the ego vehicle 1002 is predicted to move. In this example, the ego vehicle 1002 is predicted to turn toward the left (west) to avoid a pedestrian 1004. Since the image-based speed-predicting neural network 230 uses the augmented images 226 as an input, the neural network 230 may take the predicted vehicle trajectory 220 into account when generating the predicted vehicle speed 232. For example, if the vehicle is predicted to turn to the left to avoid the pedestrian 1004, then the predicted vehicle speed 232 may be reduced so that the vehicle may turn to the left with greater comfort to riders.

In particular embodiments, if the top view 1000 is generated or otherwise corresponds to a time T₀, then the predicted vehicle trajectory 1006 may correspond to the time T₀+1 and subsequent times. The first point of the predicted vehicle trajectory 1006 may be, for example, the predicted vehicle location 220 closest to the location of the vehicle 1002 at the south end of the top view 1000. A second one of the predicted vehicle locations 1006 may be, for example, the predicted vehicle location 220 above and to the left of the first one. Thus, the points 220 of the predicted vehicle trajectory 1006 form a path from the ego vehicle location 1002 along which the ego vehicle is expected to move. One or more predicted trajectories of other agents, such as the car 904, may similarly be added to the top view 100 based on the predicted agent points 222.

In particular embodiments, the image-based speed-predicting neural network 230 may generate the predicted vehicle speed 232 based on the predicted trajectory 218 because the augmented images 226 include predicted trajectory 1006 (e.g., in a top view) and/or 1106 (e.g. in a front view) of that represent predicted trajectory 218. The predicted trajectory renderer 224 may have added the predicted trajectory 1106 (based on the predicted vehicle locations 220 and/or predicted agent locations 222 of the predicted trajectories 218) to the augmented images 226. Although the predicted trajectories 1006, 1106 are shown as circles, each of the predicted trajectories 1006, 1106 may be, e.g., one or more pixels, or other graphical features (e.g., squares, or other shapes) on one of the augmented images 226 at locations (in the image) that correspond to the predicted vehicle locations 220.

FIG. 11 illustrates an example front view image 1100 that includes a predicted trajectory 1106 and a pedestrian 1104. In particular embodiments, the images 214 may be front, side, and/or rear-view images, and the prediction module 215 may generate the vehicle target speed 236 and/or predicted trajectory 218 based on the front, side, and/or rear-view images 214. The predicted trajectory 1106 is similar to the predicted trajectory 1006, but is at locations in the front view image 1100 appropriate for the front-view 3D perspective instead of the top-view 2D perspective. The front view image 1100 may be an image of the residential environment 800 captured by one or more cameras of the vehicle. The front view image 1100 may be generated by the perception module 201 from the sensor data 160 (e.g., without performing a perspective transform 206 to a top-down view).

The predicted trajectory renderer 224 may generate the front view image 1100 by adding the predicted trajectory 1106 to the front view image at the appropriate location coordinates to form an augmented image 226. The speed-predicting neural network 230 may receive the front view image 1100 (as an augmented image 226) and predict the vehicle speed 232 based on the front view image 1100 (e.g., instead of a top-view image).

The predicted trajectory 1106 may be rendered as one or more circles at locations based on the predicted trajectory 218 of the ego vehicle. Each point of the predicted trajectory 1106 may correspond to a time in the future. The predicted trajectory 1106 may form a path through which the ego vehicle is predicted to move. In this example, the ego vehicle is predicted to turn toward the left (west) to avoid the pedestrian 1104. Since the speed-predicting neural network 230 uses the augmented images 226 as an input, the neural network 230 may take the predicted vehicle locations 1106 in the augmented images 226 into account when generating the predicted vehicle speed 232. For example, if the vehicle is predicted to turn to the left to avoid the pedestrian 1104 as shown, then the predicted vehicle speed 232 may be reduced so that the vehicle may turn to the left with greater comfort to riders.

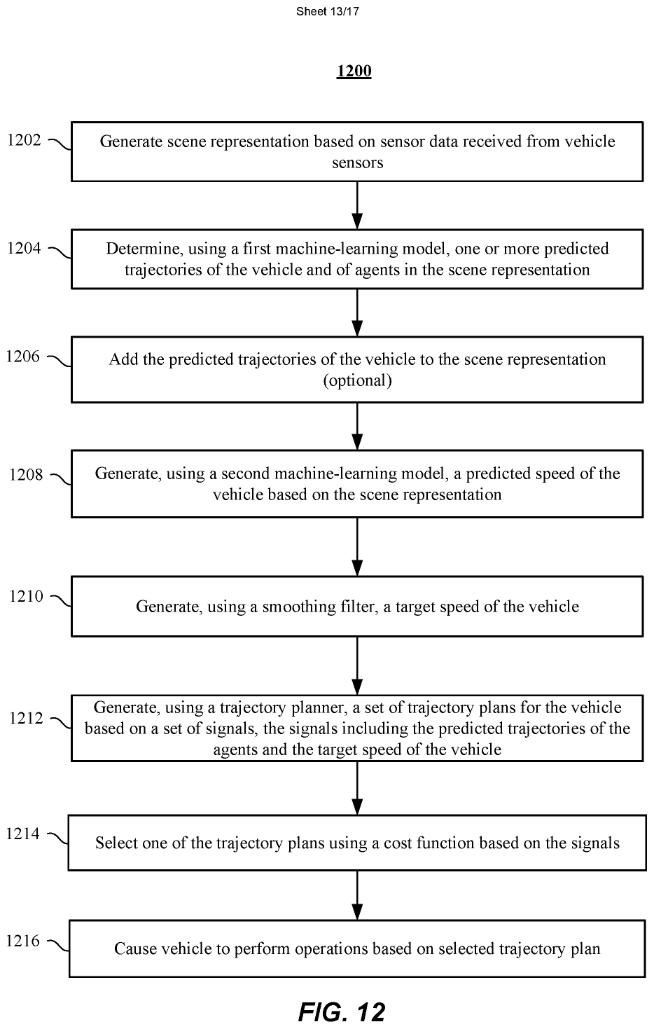

FIG. 12 illustrates an example method 1200 for predicting appropriate vehicle speeds and generating trajectory plans based on the appropriate speeds. The method may begin at step 1202, where a vehicle system may generate scene representation based on sensor data received from vehicle sensors. At step 1204, the vehicle system may determine, using a first machine-learning model, one or more predicted trajectories of the vehicle and of agents in the scene representation. At step 1206, the vehicle system may add the predicted trajectories of the vehicle to the scene representation (optional). At step 1208, the vehicle system may generate, using a second machine-learning model, a predicted speed of the vehicle based on the scene representation. At step 1210, the vehicle system may generate, using a smoothing filter, a target speed of the vehicle. At step 1212, the vehicle system may generate, using a trajectory planner, a set of trajectory plans for the vehicle based on a set of signals, the signals including the predicted trajectories of the agents and the target speed of the vehicle. At step 1214, the vehicle system may select one of the trajectory plans using a cost function based on the signals. At step 1216, the vehicle system may cause vehicle to perform operations based on selected trajectory plan.

Particular embodiments may repeat one or more steps of the method of FIG. 12, where appropriate. Although this disclosure describes and illustrates particular steps of the method of FIG. 12 as occurring in a particular order, this disclosure contemplates any suitable steps of the method of FIG. 12 occurring in any suitable order. Moreover, although this disclosure describes and illustrates an example method for predicting appropriate vehicle speeds and generating trajectory plans based on the appropriate speeds including the particular steps of the method of FIG. 12, this disclosure contemplates any suitable method for predicting appropriate vehicle speeds and generating trajectory plans based on the appropriate speeds including any suitable steps, which may include all, some, or none of the steps of the method of FIG. 12, where appropriate. Furthermore, although this disclosure describes and illustrates particular components, devices, or systems carrying out particular steps of the method of FIG. 12, this disclosure contemplates any suitable combination of any suitable components, devices, or systems carrying out any suitable steps of the method of FIG. 12.

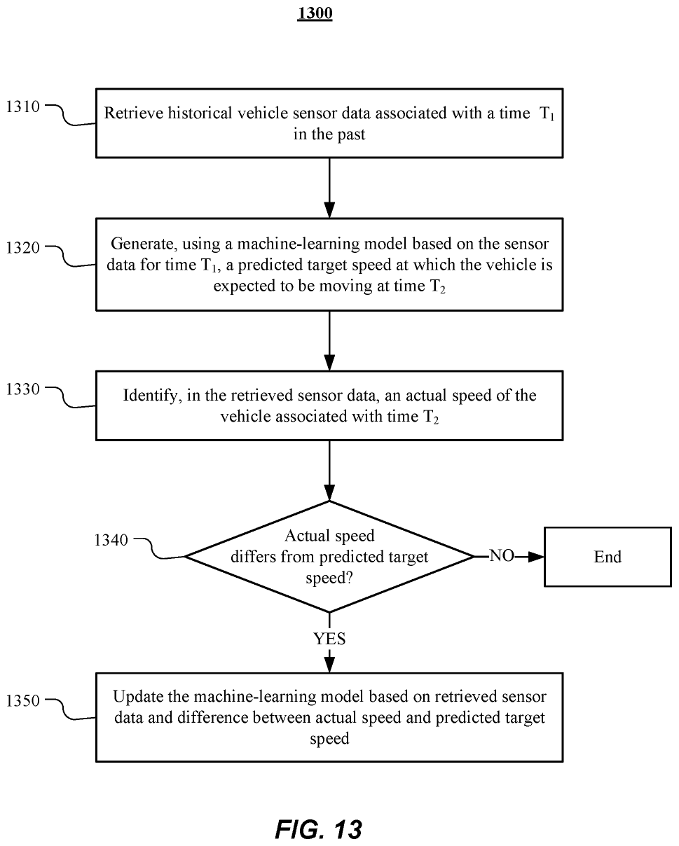

FIG. 13 illustrates an example method 1300 for training a machine-learning model to predict appropriate target speeds. The method may begin at step 1302, where a vehicle system may retrieve historical vehicle sensor data associated with a time T₁ in the past. At step 1320, the vehicle system may generate, using a machine-learning model based on the sensor data for time T₁, a predicted target speed at which the vehicle is expected to be moving at time T₂. At step 1330, the vehicle system may Identify, in the retrieved sensor data, an actual speed of the vehicle associated with time T₂. At step 1340, the vehicle system may determine whether the actual speed differs from predicted target speed. If not, the method 1500 may end. If so, at step 1350, the vehicle system may update the machine-learning model based on retrieved sensor data and difference between actual speed and predicted target speed.

Particular embodiments may repeat one or more steps of the method of FIG. 13, where appropriate. Although this disclosure describes and illustrates particular steps of the method of FIG. 13 as occurring in a particular order, this disclosure contemplates any suitable steps of the method of FIG. 13 occurring in any suitable order. Moreover, although this disclosure describes and illustrates an example method for training a machine-learning model to predict appropriate target speeds including the particular steps of the method of FIG. 13, this disclosure contemplates any suitable method for training a machine-learning model to predict appropriate target speeds including any suitable steps, which may include all, some, or none of the steps of the method of FIG. 13, where appropriate. Furthermore, although this disclosure describes and illustrates particular components, devices, or systems carrying out particular steps of the method of FIG. 13, this disclosure contemplates any suitable combination of any suitable components, devices, or systems carrying out any suitable steps of the method of FIG. 13.

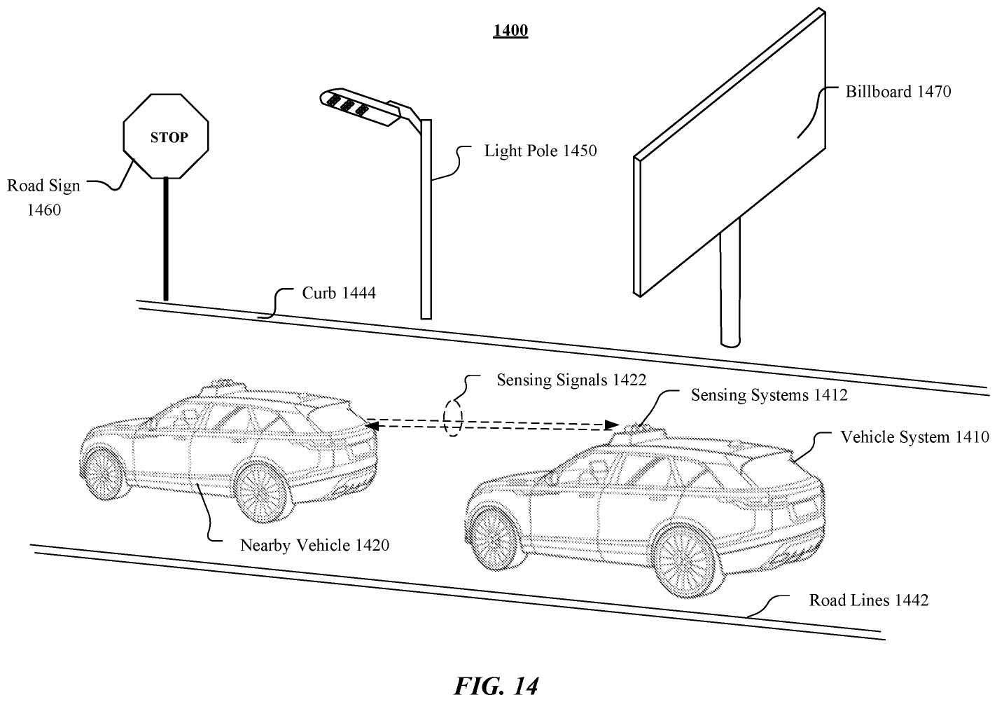

FIG. 14 illustrates an example situation 1400 for a data-gathering vehicle system 1410 to collect vehicle data of a nearby vehicle 1420 and contextual data of the surrounding environment. In particular embodiments, the vehicle system 1410 (e.g., autonomous vehicles, manually-driven vehicles, computer-assisted-driven vehicles, human-machine hybrid-driven vehicles, etc.) may have a number of sensors or sensing systems 1412 for monitoring the vehicle status, other vehicles and the surrounding environment. The sensors or sensing systems 1412 may include, for example, but are not limited to, cameras (e.g., optical camera, thermal cameras), LiDARs, radars, speed sensors, steering angle sensors, braking pressure sensors, a GPS, inertial measurement units (IMUs), acceleration sensors, etc. The vehicle system 1410 may include one or more computing systems (e.g., a data collection device, a mobile phone, a tablet, a mobile computer, an on-board computer, a high-performance computer) to collect data about the vehicle, the nearby vehicles, the surrounding environment, etc. In particular embodiments, the vehicle system 1410 may collect data of the vehicle itself related to, for example, but not limited to, vehicle speeds, moving directions, wheel directions, steering angles, steering force on the steering wheel, pressure of braking pedal, pressure of acceleration pedal, acceleration (e.g., based on IMU outputs), rotation rates (e.g., based on IMU/gyroscope outputs), vehicle moving paths, vehicle trajectories, locations (e.g., GPS coordination), signal status (e.g., on-off states of turning signals, braking signals, emergence signals), human driver eye movement, head movement, etc.

In particular embodiments, the vehicle system 1410 may use one or more sensing signals 1422 of the sensing system 1412 to collect data of the nearby vehicle 1420. For example, the vehicle system 1410 may collect the vehicle data and driving behavior data related to, for example, but not limited to, vehicle images, vehicle speeds, acceleration, vehicle moving paths, vehicle driving trajectories, locations, turning signal status (e.g., on-off state of turning signals), braking signal status, a distance to another vehicle, a relative speed to another vehicle, a distance to a pedestrian, a relative speed to a pedestrian, a distance to a traffic signal, a distance to an intersection, a distance to a road sign, a distance to curb, a relative position to a road line, an object in a field of view of the vehicle, positions of other traffic agents, aggressiveness metrics of other vehicles, etc. In addition, the sensing system 1412 may be used to identify the nearby vehicle 1420, which could be based on an anonymous vehicle identifier based on the license plate number, a QR code, or any other suitable identifier that uniquely identifies the nearby vehicle.

In particular embodiments, the vehicle system 1410 may collect contextual data of the surrounding environment based on one or more sensors associated with the vehicle system 1410. In particular embodiments, the vehicle system 1410 may collect data related to road conditions or one or more objects of the surrounding environment, for example, but not limited to, road layout, pedestrians, other vehicles (e.g., 1420), traffic status (e.g., number of nearby vehicles, number of pedestrians, traffic signals), time of day (e.g., morning rush hours, evening rush hours, non-busy hours), type of traffic (e.g., high speed moving traffic, accident events, slow moving traffic), locations (e.g., GPS coordination), road conditions (e.g., constructing zones, school zones, wet surfaces, ice surfaces), intersections, road signs (e.g., stop sign 1460, road lines 1442, cross walk), nearby objects (e.g., curb 1444, light poles 1450, billboard 1470), buildings, weather conditions (e.g., raining, fog, sunny, hot weather, cold weather), or any objects or agents in the surrounding environment. In particular embodiments, the contextual data of the vehicle may include navigation data of the vehicle, for example, a navigation map, a navigating target place, a trajectory, an estimated time of arriving, a detour, etc. In particular embodiments, the contextual data of the vehicle may include camera-based localization data including, for example, but not limited to, a point cloud, a depth of view, a two-dimensional profile of environment, a three-dimensional profile of environment, stereo images of a scene, a relative position (e.g., a distance, an angle) to an environmental object, a relative position (e.g., a distance, an angle) to road lines, a relative position in the current environment, a traffic status (e.g., high traffic, low traffic), driving trajectories of other vehicles, motions of other traffic agents, speeds of other traffic agents, moving directions of other traffic agents, signal statuses of other vehicles, etc. In particular embodiments, the vehicle system 1410 may have a perception of the surrounding environment based on the contextual data collected through one or more sensors in real-time and/or based on historical contextual data stored in a vehicle model database.

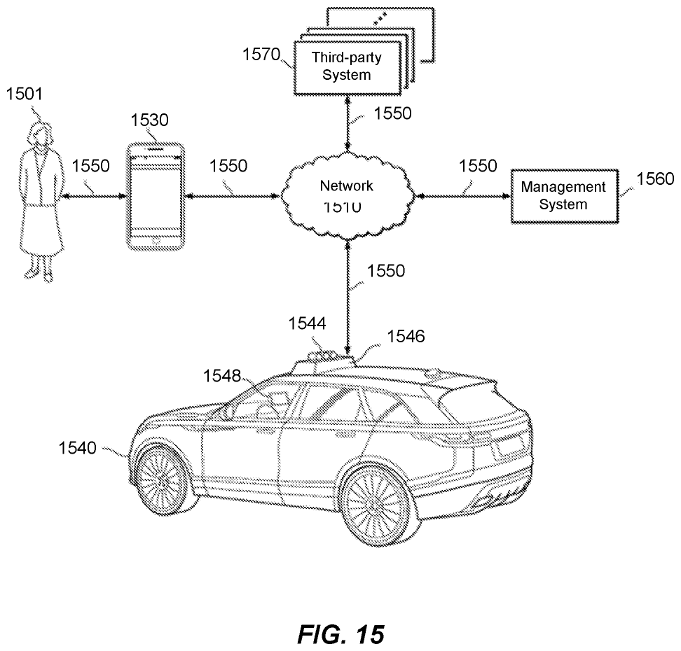

FIG. 15 illustrates an example block diagram of a transportation management environment for matching ride requestors with autonomous vehicles. In particular embodiments, the environment may include various computing entities, such as a user computing device 1530 of a user 1501 (e.g., a ride provider or requestor), a transportation management system 1560, an autonomous vehicle 1540, and one or more third-party system 1570. The computing entities may be communicatively connected over any suitable network 1510. As an example and not by way of limitation, one or more portions of network 1510 may include an ad hoc network, an extranet, a virtual private network (VPN), a local area network (LAN), a wireless LAN (WLAN), a wide area network (WAN), a wireless WAN (WWAN), a metropolitan area network (MAN), a portion of the Internet, a portion of Public Switched Telephone Network (PSTN), a cellular network, or a combination of any of the above. In particular embodiments, any suitable network arrangement and protocol enabling the computing entities to communicate with each other may be used. Although FIG. 15 illustrates a single user device 1530, a single transportation management system 1560, a single vehicle 1540, a plurality of third-party systems 1570, and a single network 1510, this disclosure contemplates any suitable number of each of these entities. As an example and not by way of limitation, the network environment may include multiple users 1501, user devices 1530, transportation management systems 1560, autonomous-vehicles 1540, third-party systems 1570, and networks 1510.

The user device 1530, transportation management system 1560, autonomous vehicle 1540, and third-party system 1570 may be communicatively connected or co-located with each other in whole or in part. These computing entities may communicate via different transmission technologies and network types. For example, the user device 1530 and the vehicle 1540 may communicate with each other via a cable or short-range wireless communication (e.g., Bluetooth, NFC, WI-FI, etc.), and together they may be connected to the Internet via a cellular network that is accessible to either one of the devices (e.g., the user device 1530 may be a smartphone with LTE connection). The transportation management system 1560 and third-party system 1570, on the other hand, may be connected to the Internet via their respective LAN/WLAN networks and Internet Service Providers (ISP). FIG. 15 illustrates transmission links 1550 that connect user device 1530, autonomous vehicle 1540, transportation management system 1560, and third-party system 1570 to communication network 1510. This disclosure contemplates any suitable transmission links 1550, including, e.g., wire connections (e.g., USB, Lightning, Digital Subscriber Line (DSL) or Data Over Cable Service Interface Specification (DOCSIS)), wireless connections (e.g., WI-FI, WiMAX, cellular, satellite, NFC, Bluetooth), optical connections (e.g., Synchronous Optical Networking (SONET), Synchronous Digital Hierarchy (SDH)), any other wireless communication technologies, and any combination thereof. In particular embodiments, one or more links 1550 may connect to one or more networks 1510, which may include in part, e.g., ad-hoc network, the Intranet, extranet, VPN, LAN, WLAN, WAN, WWAN, MAN, PSTN, a cellular network, a satellite network, or any combination thereof. The computing entities need not necessarily use the same type of transmission link 1550. For example, the user device 1530 may communicate with the transportation management system via a cellular network and the Internet, but communicate with the autonomous vehicle 1540 via Bluetooth or a physical wire connection.

In particular embodiments, the transportation management system 1560 may fulfill ride requests for one or more users 1501 by dispatching suitable vehicles. The transportation management system 1560 may receive any number of ride requests from any number of ride requestors 1501. In particular embodiments, a ride request from a ride requestor 1501 may include an identifier that identifies the ride requestor in the system 1560. The transportation management system 1560 may use the identifier to access and store the ride requestor's 1501 information, in accordance with the requestor's 1501 privacy settings. The ride requestor's 1501 information may be stored in one or more data stores (e.g., a relational database system) associated with and accessible to the transportation management system 1560. In particular embodiments, ride requestor information may include profile information about a particular ride requestor 1501. In particular embodiments, the ride requestor 1501 may be associated with one or more categories or types, through which the ride requestor 1501 may be associated with aggregate information about certain ride requestors of those categories or types. Ride information may include, for example, preferred pick-up and drop-off locations, driving preferences (e.g., safety comfort level, preferred speed, rates of acceleration/deceleration, safety distance from other vehicles when travelling at various speeds, trajectory, etc.), entertainment preferences and settings (e.g., preferred music genre or playlist, audio volume, display brightness, etc.), temperature settings, whether conversation with the driver is welcomed, frequent destinations, historical riding patterns (e.g., time of day of travel, starting and ending locations, etc.), preferred language, age, gender, or any other suitable information. In particular embodiments, the transportation management system 1560 may classify a user 1501 based on known information about the user 1501 (e.g., using machine-learning classifiers), and use the classification to retrieve relevant aggregate information associated with that class. For example, the system 1560 may classify a user 1501 as a young adult and retrieve relevant aggregate information associated with young adults, such as the type of music generally preferred by young adults.

Transportation management system 1560 may also store and access ride information. Ride information may include locations related to the ride, traffic data, trajectory options, optimal pick-up or drop-off locations for the ride, or any other suitable information associated with a ride. As an example and not by way of limitation, when the transportation management system 1560 receives a request to travel from San Francisco International Airport (SFO) to Palo Alto, Calif., the system 1560 may access or generate any relevant ride information for this particular ride request. The ride information may include, for example, preferred pick-up locations at SFO; alternate pick-up locations in the event that a pick-up location is incompatible with the ride requestor (e.g., the ride requestor may be disabled and cannot access the pick-up location) or the pick-up location is otherwise unavailable due to construction, traffic congestion, changes in pick-up/drop-off rules, or any other reason; one or more trajectories to navigate from SFO to Palo Alto; preferred off-ramps for a type of user; or any other suitable information associated with the ride. In particular embodiments, portions of the ride information may be based on historical data associated with historical rides facilitated by the system 1560. For example, historical data may include aggregate information generated based on past ride information, which may include any ride information described herein and telemetry data collected by sensors in autonomous vehicles and/or user devices. Historical data may be associated with a particular user (e.g., that particular user's preferences, common trajectories s, etc.), a category/class of users (e.g., based on demographics), and/or all users of the system 1560. For example, historical data specific to a single user may include information about past rides that particular user has taken, including the locations at which the user is picked up and dropped off, music the user likes to listen to, traffic information associated with the rides, time of the day the user most often rides, and any other suitable information specific to the user. As another example, historical data associated with a category/class of users may include, e.g., common or popular ride preferences of users in that category/class, such as teenagers preferring pop music, ride requestors who frequently commute to the financial district may prefer to listen to the news, etc. As yet another example, historical data associated with all users may include general usage trends, such as traffic and ride patterns. Using historical data, the system 1560 in particular embodiments may predict and provide ride suggestions in response to a ride request. In particular embodiments, the system 1560 may use machine-learning, such as neural networks, regression algorithms, instance-based algorithms (e.g., k-Nearest Neighbor), decision-tree algorithms, Bayesian algorithms, clustering algorithms, association-rule-learning algorithms, deep-learning algorithms, dimensionality-reduction algorithms, ensemble algorithms, and any other suitable machine-learning algorithms known to persons of ordinary skill in the art. The machine-learning models may be trained using any suitable training algorithm, including supervised learning based on labeled training data, unsupervised learning based on unlabeled training data, and/or semi-supervised learning based on a mixture of labeled and unlabeled training data.

In particular embodiments, transportation management system 1560 may include one or more server computers. Each server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, transportation management system 1560 may include one or more data stores. The data stores may be used to store various types of information, such as ride information, ride requestor information, ride provider information, historical information, third-party information, or any other suitable type of information. In particular embodiments, the information stored in the data stores may be organized according to specific data structures. In particular embodiments, each data store may be a relational, columnar, correlation, or any other suitable type of database system. Although this disclosure describes or illustrates particular types of databases, this disclosure contemplates any suitable types of databases. Particular embodiments may provide interfaces that enable a user device 1530 (which may belong to a ride requestor or provider), a transportation management system 1560, vehicle system 1540, or a third-party system 1570 to process, transform, manage, retrieve, modify, add, or delete the information stored in the data store.

In particular embodiments, transportation management system 1560 may include an authorization server (or any other suitable component(s)) that allows users 1501 to opt-in to or opt-out of having their information and actions logged, recorded, or sensed by transportation management system 1560 or shared with other systems (e.g., third-party systems 1570). In particular embodiments, a user 1501 may opt-in or opt-out by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users 1501 of transportation management system 1560 through blocking, data hashing, anonymization, or other suitable techniques as appropriate.

In particular embodiments, third-party system 1570 may be a network-addressable computing system that may provide HD maps or host GPS maps, customer reviews, music or content, weather information, or any other suitable type of information. Third-party system 1570 may generate, store, receive, and send relevant data, such as, for example, map data, customer review data from a customer review website, weather data, or any other suitable type of data. Third-party system 1570 may be accessed by the other computing entities of the network environment either directly or via network 1510. For example, user device 1530 may access the third-party system 1570 via network 1510, or via transportation management system 1560. In the latter case, if credentials are required to access the third-party system 1570, the user 1501 may provide such information to the transportation management system 1560, which may serve as a proxy for accessing content from the third-party system 1570.

In particular embodiments, user device 1530 may be a mobile computing device such as a smartphone, tablet computer, or laptop computer. User device 1530 may include one or more processors (e.g., CPU and/or GPU), memory, and storage. An operating system and applications may be installed on the user device 1530, such as, e.g., a transportation application associated with the transportation management system 1560, applications associated with third-party systems 1570, and applications associated with the operating system. User device 1530 may include functionality for determining its location, direction, or orientation, based on integrated sensors such as GPS, compass, gyroscope, or accelerometer. User device 1530 may also include wireless transceivers for wireless communication and may support wireless communication protocols such as Bluetooth, near-field communication (NFC), infrared (IR) communication, WI-FI, and/or 2G/3G/4G/LTE mobile communication standard. User device 1530 may also include one or more cameras, scanners, touchscreens, microphones, speakers, and any other suitable input-output devices.

In particular embodiments, the vehicle 1540 may be an autonomous vehicle and equipped with an array of sensors 1544, a navigation system 1546, and a ride-service computing device 1548. In particular embodiments, a fleet of autonomous vehicles 1540 may be managed by the transportation management system 1560. The fleet of autonomous vehicles 1540, in whole or in part, may be owned by the entity associated with the transportation management system 1560, or they may be owned by a third-party entity relative to the transportation management system 1560. In either case, the transportation management system 1560 may control the operations of the autonomous vehicles 1540, including, e.g., dispatching select vehicles 1540 to fulfill ride requests, instructing the vehicles 1540 to perform select operations (e.g., head to a service center or charging/fueling station, pull over, stop immediately, self-diagnose, lock/unlock compartments, change music station, change temperature, and any other suitable operations), and instructing the vehicles 1540 to enter select operation modes (e.g., operate normally, drive at a reduced speed, drive under the command of human operators, and any other suitable operational modes).

In particular embodiments, the autonomous vehicles 1540 may receive data from and transmit data to the transportation management system 1560 and the third-party system 1570. Example of received data may include, e.g., instructions, new software or software updates, maps, 3D models, trained or untrained machine-learning models, location information (e.g., location of the ride requestor, the autonomous vehicle 1540 itself, other autonomous vehicles 1540, and target destinations such as service centers), navigation information, traffic information, weather information, entertainment content (e.g., music, video, and news) ride requestor information, ride information, and any other suitable information. Examples of data transmitted from the autonomous vehicle 1540 may include, e.g., telemetry and sensor data, determinations/decisions based on such data, vehicle condition or state (e.g., battery/fuel level, tire and brake conditions, sensor condition, speed, odometer, etc.), location, navigation data, passenger inputs (e.g., through a user interface in the vehicle 1540, passengers may send/receive data to the transportation management system 1560 and/or third-party system 1570), and any other suitable data.

In particular embodiments, autonomous vehicles 1540 may also communicate with each other as well as other traditional human-driven vehicles, including those managed and not managed by the transportation management system 1560. For example, one vehicle 1540 may communicate with another vehicle data regarding their respective location, condition, status, sensor reading, and any other suitable information. In particular embodiments, vehicle-to-vehicle communication may take place over direct short-range wireless connection (e.g., WI-FI, Bluetooth, NFC) and/or over a network (e.g., the Internet or via the transportation management system 1560 or third-party system 1570).

In particular embodiments, an autonomous vehicle 1540 may obtain and process sensor/telemetry data. Such data may be captured by any suitable sensors. For example, the vehicle 1540 may have aa Light Detection and Ranging (LiDAR) sensor array of multiple LiDAR transceivers that are configured to rotate 360°, emitting pulsed laser light and measuring the reflected light from objects surrounding vehicle 1540. In particular embodiments, LiDAR transmitting signals may be steered by use of a gated light valve, which may be a MEMs device that directs a light beam using the principle of light diffraction. Such a device may not use a gimbaled mirror to steer light beams in 360° around the autonomous vehicle. Rather, the gated light valve may direct the light beam into one of several optical fibers, which may be arranged such that the light beam may be directed to many discrete positions around the autonomous vehicle. Thus, data may be captured in 360° around the autonomous vehicle, but no rotating parts may be necessary. A LiDAR is an effective sensor for measuring distances to targets, and as such may be used to generate a three-dimensional (3D) model of the external environment of the autonomous vehicle 1540. As an example and not by way of limitation, the 3D model may represent the external environment including objects such as other cars, curbs, debris, objects, and pedestrians up to a maximum range of the sensor arrangement (e.g., 50, 100, or 200 meters). As another example, the autonomous vehicle 1540 may have optical cameras pointing in different directions. The cameras may be used for, e.g., recognizing roads, lane markings, street signs, traffic lights, police, other vehicles, and any other visible objects of interest. To enable the vehicle 1540 to “see” at night, infrared cameras may be installed. In particular embodiments, the vehicle may be equipped with stereo vision for, e.g., spotting hazards such as pedestrians or tree branches on the road. As another example, the vehicle 1540 may have radars for, e.g., detecting other vehicles and/or hazards afar. Furthermore, the vehicle 1540 may have ultrasound equipment for, e.g., parking and obstacle detection. In addition to sensors enabling the vehicle 1540 to detect, measure, and understand the external world around it, the vehicle 1540 may further be equipped with sensors for detecting and self-diagnosing the vehicle's own state and condition. For example, the vehicle 1540 may have wheel sensors for, e.g., measuring velocity; global positioning system (GPS) for, e.g., determining the vehicle's current geolocation; and/or inertial measurement units, accelerometers, gyroscopes, and/or odometer systems for movement or motion detection. While the description of these sensors provides particular examples of utility, one of ordinary skill in the art would appreciate that the utilities of the sensors are not limited to those examples. Further, while an example of a utility may be described with respect to a particular type of sensor, it should be appreciated that the utility may be achieved using any combination of sensors. For example, an autonomous vehicle 1540 may build a 3D model of its surrounding based on data from its LiDAR, radar, sonar, and cameras, along with a pre-generated map obtained from the transportation management system 1560 or the third-party system 1570. Although sensors 1544 appear in a particular location on autonomous vehicle 1540 in FIG. 15, sensors 1544 may be located in any suitable location in or on autonomous vehicle 1540. Example locations for sensors include the front and rear bumpers, the doors, the front windshield, on the side panel, or any other suitable location.

In particular embodiments, the autonomous vehicle 1540 may be equipped with a processing unit (e.g., one or more CPUs and GPUs), memory, and storage. The vehicle 1540 may thus be equipped to perform a variety of computational and processing tasks, including processing the sensor data, extracting useful information, and operating accordingly. For example, based on images captured by its cameras and a machine-vision model, the vehicle 1540 may identify particular types of objects captured by the images, such as pedestrians, other vehicles, lanes, curbs, and any other objects of interest.

In particular embodiments, the autonomous vehicle 1540 may have a navigation system 1546 responsible for safely navigating the autonomous vehicle 1540. In particular embodiments, the navigation system 1546 may take as input any type of sensor data from, e.g., a Global Positioning System (GPS) module, inertial measurement unit (IMU), LiDAR sensors, optical cameras, radio frequency (RF) transceivers, or any other suitable telemetry or sensory mechanisms. The navigation system 1546 may also utilize, e.g., map data, traffic data, accident reports, weather reports, instructions, target destinations, and any other suitable information to determine navigation trajectories and particular driving operations (e.g., slowing down, speeding up, stopping, swerving, etc.). In particular embodiments, the navigation system 1546 may use its determinations to control the vehicle 1540 to operate in prescribed manners and to guide the autonomous vehicle 1540 to its destinations without colliding into other objects. Although the physical embodiment of the navigation system 1546 (e.g., the processing unit) appears in a particular location on autonomous vehicle 1540 in FIG. 15, navigation system 1546 may be located in any suitable location in or on autonomous vehicle 1540. Example locations for navigation system 1546 include inside the cabin or passenger compartment of autonomous vehicle 1540, near the engine/battery, near the front seats, rear seats, or in any other suitable location.

In particular embodiments, the autonomous vehicle 1540 may be equipped with a ride-service computing device 1548, which may be a tablet or any other suitable device installed by transportation management system 1560 to allow the user to interact with the autonomous vehicle 1540, transportation management system 1560, other users 1501, or third-party systems 1570. In particular embodiments, installation of ride-service computing device 1548 may be accomplished by placing the ride-service computing device 1548 inside autonomous vehicle 1540, and configuring it to communicate with the vehicle 1540 via a wire or wireless connection (e.g., via Bluetooth). Although FIG. 15 illustrates a single ride-service computing device 1548 at a particular location in autonomous vehicle 1540, autonomous vehicle 1540 may include several ride-service computing devices 1548 in several different locations within the vehicle. As an example and not by way of limitation, autonomous vehicle 1540 may include four ride-service computing devices 1548 located in the following places: one in front of the front-left passenger seat (e.g., driver's seat in traditional U.S. automobiles), one in front of the front-right passenger seat, one in front of each of the rear-left and rear-right passenger seats. In particular embodiments, ride-service computing device 1548 may be detachable from any component of autonomous vehicle 1540. This may allow users to handle ride-service computing device 1548 in a manner consistent with other tablet computing devices. As an example and not by way of limitation, a user may move ride-service computing device 1548 to any location in the cabin or passenger compartment of autonomous vehicle 1540, may hold ride-service computing device 1548, or handle ride-service computing device 1548 in any other suitable manner. Although this disclosure describes providing a particular computing device in a particular manner, this disclosure contemplates providing any suitable computing device in any suitable manner.

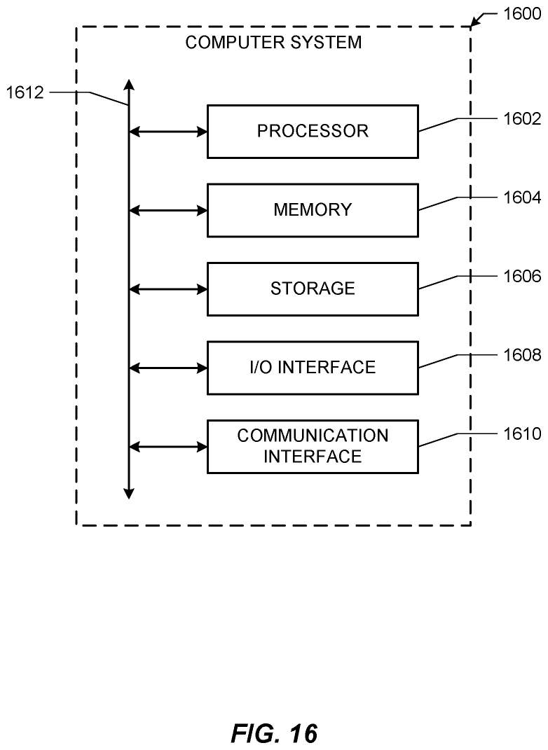

FIG. 16 illustrates an example computer system 1600. In particular embodiments, one or more computer systems 1600 perform one or more steps of one or more methods described or illustrated herein. In particular embodiments, one or more computer systems 1600 provide the functionalities described or illustrated herein. In particular embodiments, software running on one or more computer systems 1600 performs one or more steps of one or more methods described or illustrated herein or provides the functionalities described or illustrated herein. Particular embodiments include one or more portions of one or more computer systems 1600. Herein, a reference to a computer system may encompass a computing device, and vice versa, where appropriate. Moreover, a reference to a computer system may encompass one or more computer systems, where appropriate.

This disclosure contemplates any suitable number of computer systems 1600. This disclosure contemplates computer system 1600 taking any suitable physical form. As example and not by way of limitation, computer system 1600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1600 may include one or more computer systems 1600; be unitary or distributed; span multiple locations; span multiple machines; span multiple data centers; or reside in a cloud, which may include one or more cloud components in one or more networks. Where appropriate, one or more computer systems 1600 may perform without substantial spatial or temporal limitation one or more steps of one or more methods described or illustrated herein. As an example and not by way of limitation, one or more computer systems 1600 may perform in real time or in batch mode one or more steps of one or more methods described or illustrated herein. One or more computer systems 1600 may perform at different times or at different locations one or more steps of one or more methods described or illustrated herein, where appropriate.

In particular embodiments, computer system 1600 includes a processor 1602, memory 1604, storage 1606, an input/output (I/O) interface 1608, a communication interface 1610, and a bus 1612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1602 includes hardware for executing instructions, such as those making up a computer program. As an example and not by way of limitation, to execute instructions, processor 1602 may retrieve (or fetch) the instructions from an internal register, an internal cache, memory 1604, or storage 1606; decode and execute them; and then write one or more results to an internal register, an internal cache, memory 1604, or storage 1606. In particular embodiments, processor 1602 may include one or more internal caches for data, instructions, or addresses. This disclosure contemplates processor 1602 including any suitable number of any suitable internal caches, where appropriate. As an example and not by way of limitation, processor 1602 may include one or more instruction caches, one or more data caches, and one or more translation lookaside buffers (TLBs). Instructions in the instruction caches may be copies of instructions in memory 1604 or storage 1606, and the instruction caches may speed up retrieval of those instructions by processor 1602. Data in the data caches may be copies of data in memory 1604 or storage 1606 that are to be operated on by computer instructions; the results of previous instructions executed by processor 1602 that are accessible to subsequent instructions or for writing to memory 1604 or storage 1606; or any other suitable data. The data caches may speed up read or write operations by processor 1602. The TLBs may speed up virtual-address translation for processor 1602. In particular embodiments, processor 1602 may include one or more internal registers for data, instructions, or addresses. This disclosure contemplates processor 1602 including any suitable number of any suitable internal registers, where appropriate. Where appropriate, processor 1602 may include one or more arithmetic logic units (ALUs), be a multi-core processor, or include one or more processors 1602. Although this disclosure describes and illustrates a particular processor, this disclosure contemplates any suitable processor.

In particular embodiments, memory 1604 includes main memory for storing instructions for processor 1602 to execute or data for processor 1602 to operate on. As an example and not by way of limitation, computer system 1600 may load instructions from storage 1606 or another source (such as another computer system 1600) to memory 1604. Processor 1602 may then load the instructions from memory 1604 to an internal register or internal cache. To execute the instructions, processor 1602 may retrieve the instructions from the internal register or internal cache and decode them. During or after execution of the instructions, processor 1602 may write one or more results (which may be intermediate or final results) to the internal register or internal cache. Processor 1602 may then write one or more of those results to memory 1604. In particular embodiments, processor 1602 executes only instructions in one or more internal registers or internal caches or in memory 1604 (as opposed to storage 1606 or elsewhere) and operates only on data in one or more internal registers or internal caches or in memory 1604 (as opposed to storage 1606 or elsewhere). One or more memory buses (which may each include an address bus and a data bus) may couple processor 1602 to memory 1604. Bus 1612 may include one or more memory buses, as described in further detail below. In particular embodiments, one or more memory management units (MMUs) reside between processor 1602 and memory 1604 and facilitate accesses to memory 1604 requested by processor 1602. In particular embodiments, memory 1604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1604 may include one or more memories 1604, where appropriate. Although this disclosure describes and illustrates particular memory, this disclosure contemplates any suitable memory.

In particular embodiments, storage 1606 includes mass storage for data or instructions. As an example and not by way of limitation, storage 1606 may include a hard disk drive (HDD), a floppy disk drive, flash memory, an optical disc, a magneto-optical disc, magnetic tape, or a Universal Serial Bus (USB) drive or a combination of two or more of these. Storage 1606 may include removable or non-removable (or fixed) media, where appropriate. Storage 1606 may be internal or external to computer system 1600, where appropriate. In particular embodiments, storage 1606 is non-volatile, solid-state memory. In particular embodiments, storage 1606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1606 taking any suitable physical form. Storage 1606 may include one or more storage control units facilitating communication between processor 1602 and storage 1606, where appropriate. Where appropriate, storage 1606 may include one or more storages 1606. Although this disclosure describes and illustrates particular storage, this disclosure contemplates any suitable storage.

In particular embodiments, I/O interface 1608 includes hardware, software, or both, providing one or more interfaces for communication between computer system 1600 and one or more I/O devices. Computer system 1600 may include one or more of these I/O devices, where appropriate. One or more of these I/O devices may enable communication between a person and computer system 1600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1608 for them. Where appropriate, I/O interface 1608 may include one or more device or software drivers enabling processor 1602 to drive one or more of these I/O devices. I/O interface 1608 may include one or more I/O interfaces 1608, where appropriate. Although this disclosure describes and illustrates a particular I/O interface, this disclosure contemplates any suitable I/O interface.

In particular embodiments, communication interface 1610 includes hardware, software, or both providing one or more interfaces for communication (such as, for example, packet-based communication) between computer system 1600 and one or more other computer systems 1600 or one or more networks. As an example and not by way of limitation, communication interface 1610 may include a network interface controller (NIC) or network adapter for communicating with an Ethernet or any other wire-based network or a wireless NIC (WNIC) or wireless adapter for communicating with a wireless network, such as a WI-FI network. This disclosure contemplates any suitable network and any suitable communication interface 1610 for it. As an example and not by way of limitation, computer system 1600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1600 may communicate with a wireless PAN (WPAN) (such as, for example, a Bluetooth WPAN), a WI-FI network, a WI-MAX network, a cellular telephone network (such as, for example, a Global System for Mobile Communications (GSM) network), or any other suitable wireless network or a combination of two or more of these. Computer system 1600 may include any suitable communication interface 1610 for any of these networks, where appropriate. Communication interface 1610 may include one or more communication interfaces 1610, where appropriate. Although this disclosure describes and illustrates a particular communication interface, this disclosure contemplates any suitable communication interface.

In particular embodiments, bus 1612 includes hardware, software, or both coupling components of computer system 1600 to each other. As an example and not by way of limitation, bus 1612 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1612 may include one or more buses 1612, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system associated with a vehicle:
receiving sensor data of an environment of the vehicle, the sensor data being captured by one or more sensors associated with the vehicle;
generating, based on the sensor data, one or more representations of the environment of the vehicle;
determining a target speed for the vehicle by processing the one or more representations of the environment of the vehicle using a machine-learning model that has been trained using human-driven vehicle speed observations and corresponding representations of environments associated with the observations;
determining a trajectory plan and a planned speed for the vehicle based on at least the target speed; and
causing the vehicle to perform one or more operations based on the trajectory plan and the planned speed.

2. The method of claim 1, wherein the one or more representations of the environment of the vehicle include encoded data corresponding to one or more detected objects, map features associated with one or more drivable roads, a speed limit for the environment of the vehicle, or a combination thereof.

3. The method of claim 1, wherein the vehicle is traveling on a road segment having a speed limit, and the one or more representations of the environment of the vehicle include encoded data corresponding to the speed limit.

4. The method of claim 3, wherein the machine-learning model has been trained on a road segment having a speed limit that differs from the speed limit for the environment of the vehicle by less than a threshold speed difference.

5. The method of claim 1, wherein the human-driven vehicle speed observations are collected for the representations of the environments associated with the observations using a human-driven vehicle, and the machine-learning model is trained using human-driven vehicle speed observations by at least:
for each of the human-driven vehicle speed observations:
determining a predicted speed for the human-driven vehicle based on the representation of the environment associated with the human-driven vehicle speed observation;
determining an actual speed for the human driven vehicle; and
updating the machine-learning model based on a difference between the predicted speed and the actual speed for the human-driven vehicle.

6. The method of claim 5, wherein each of the representations of the environments associated with the observations includes encoded data corresponding to a speed limit.

7. The method of claim 5, wherein the actual speed for the human driven vehicle is specified by the human-driven vehicle speed observation.

8. The method of claim 1, wherein determining the target speed for the vehicle by processing the one or more representations of the environment of the vehicle using the machine-learning model comprises identifying, based on one or more weights associated with the machine-learning model, a correspondence between the representations of the environment of the vehicle and the target speed.

9. The method of claim 1, wherein the target speed is represented as one of: (a) a numeric value, (b) a range comprising a lower limit and an upper limit, or (c) a set of ranges, wherein each of the ranges comprises a lower limit and an upper limit, and each of the ranges is associated with a probability that the associated range includes an optimal value of the target speed.

10. The method of claim 1, wherein determining the trajectory plan and the planned speed for the vehicle based on at least the target speed comprises:
generating a plurality of trajectory plans for the vehicle using a trajectory planner, wherein each of the trajectory plans comprises a trajectory;
determining a score for each of the trajectory plans using a cost function, wherein the cost function is based on one or more scoring criteria, and at least one of the scoring criteria is based on the target speed and the trajectory for which the score is being determined; and
wherein the trajectory plan corresponds to the one of the trajectory plans having the highest score.

11. The method of claim 10, wherein for each of the trajectory plans, the one or more scoring criteria is based on a difference between the target speed and a planned speed associated with the each of the trajectory plans.

12. The method of claim 1, wherein causing the vehicle to perform one or more operations comprises causing the vehicle to accelerate or decelerate to reach the planned speed.

13. The method of claim 1, wherein determining the target speed for the vehicle by processing the one or more representations of the environment of the vehicle using the machine-learning model comprises:
determining a predicted trajectory of the vehicle; and
adding a representation of the predicted trajectory of the vehicle to the one or more representations of the environment of the vehicle,
wherein determining the target speed comprises processing the representation of the predicted trajectory of the vehicle.

14. The method of claim 13, wherein the one or more representations of the environment of the vehicle comprise one or more images, and the representation of the predicted trajectory of the vehicle is added to the one or more representations of the environment of the vehicle by rendering the predicted trajectory in the images.

15. The method of claim 13, wherein the one or more representations of the environment of the vehicle further include one or more past representations of one or more environments of the vehicle associated with one or more corresponding times in the past,
wherein differences in locations of features between different ones of the past representations correspond to a speed at which the features moved in the one or more past representations, and
wherein the target speed for the vehicle is further determined by processing the differences in locations of features between different ones of the past representations.

16. The method of claim 1, wherein the one or more representations of the environment of the vehicle comprise images, the features comprise locations of pixels, colors of pixels, or a combination thereof, and the machine-learning model comprises a convolutional neural network.

17. The method of claim 1, wherein the representations of the environment of the vehicle comprise points, and the features comprise locations of points, point-feature values, or a combination thereof, and the machine-learning model comprises a point-based neural network.

18. The method of claim 1, wherein the human-driven vehicle speed observations are for an area.

19. A system comprising: one or more processors and one or more computer-readable non-transitory storage media coupled to one or more of the processors, the one or more computer-readable non-transitory storage media comprising instructions operable when executed by one or more of the processors to cause the system to:
receive sensor data of an environment of the vehicle, the sensor data being captured by one or more sensors associated with the vehicle;
generate, based on the sensor data, one or more representations of the environment of the vehicle;
determine a target speed for the vehicle by processing the one or more representations of the environment of the vehicle using a machine-learning model that has been trained using human-driven vehicle speed observations and corresponding representations of environments associated with the observations;
determine a trajectory plan and a planned speed for the vehicle based on at least the target speed; and
cause the vehicle to perform one or more operations based on the trajectory plan and the planned speed.

20. One or more computer-readable non-transitory storage media embodying software that is operable when executed to cause one or more processors to perform operations comprising:
receiving sensor data of an environment of the vehicle, the sensor data being captured by one or more sensors associated with the vehicle;
generating, based on the sensor data, one or more representations of the environment of the vehicle;
determining a target speed for the vehicle by processing the one or more representations of the environment of the vehicle using a machine-learning model that has been trained using human-driven vehicle speed observations and corresponding representations of environments associated with the observations;
determining a trajectory plan and a planned speed for the vehicle based on at least the target speed; and
causing the vehicle to perform one or more operations based on the trajectory plan and the planned speed.
